(19) United States
(12) Patent Application Publication
(10) Pub. No.: US 2009/0133105 A1
(43) Pub. Date: May 21, 2009

(54) MULTI-MEDIUM WIDE AREA COMMUNICATION NETWORK

(76) Inventor: James David LARSEN, Woodinville, WA (US)

Correspondence Address: LADAS & PARRY LLP, 224 SOUTH MICHIGAN AVENUE, SUITE 1600, CHICAGO, IL, 60604, US

(21) Appl. No.: 11/914,396

(22) PCT Filed: May 16, 2006
(86) PCT No.: PCT/IB06/01274

§ 371 Date: Jan. 10, 2008

Related U.S. Application Data
(60) Provisional application No. 60/681,927, filed on May 16, 2005.

(51) Int. Cl. H04L 9/32; H04L 12/56

(52) U.S. Cl. 726/5; 370/401

(57) ABSTRACT

A communication network including a primary network, and an auxiliary network. The primary network includes wireless stations each able to transmit and receive data over the primary network, and bridge stations able to transmit and receive data both over the primary network and over the auxiliary network. The auxiliary network includes auxiliary stations and bridge stations each able to transmit and receive data over the auxiliary network. At each bridge station, the activity of other stations on both the primary network and the auxiliary network is monitored to establish the availability of intermediate stations for onward transmission of message data from an originating station to a destination station. Message data is transmitted from the originating station to the destination station via at least one opportunistically selected intermediate station, including at least one bridge station.

### BACKGROUND OF THE INVENTION

This invention relates to a communication network of the kind having a number of stations able to communicate with each other, in which an originating station is able to send message data to a destination station via at least one opportunistically selected intermediate station.

For the purposes of this specification, such a communication network will be referred to as an Opportunity Driven Multiple Access (ODMA) network.

A number of prior patent specifications have described multi-station ODMA networks in which data may be transmitted over a number of hops from an originating station (fixed or mobile) to a destination station (fixed or mobile) predominantly through a wireless medium. This method of operation is referred to in this document as “ODMA over Wireless.” However, in certain circumstances it may not be desirable or possible to transmit the data over only the wireless medium. For example, the originating and destination stations may not be within range of each other through wireless connectivity (within an acceptable maximum number of hops), or it may be more efficient to utilize an auxiliary medium, such as a wired medium, to achieve one or more of the hops in the transmission (such transmission is referred to herein as “ODMA over Wire”). Typically this situation will arise most often where the originating and destination stations are geographically remote relative to one another, and indeed may well be in other regions, countries or even continents.

It is an object of the invention to provide a communication network and method of operation thereof that permit both ODMA over Wireless and ODMA over Wire.

### SUMMARY OF THE INVENTION

According to a first aspect of the invention there is provided a method of operating a communication network, comprising a primary network and an auxiliary network, including a plurality of primary stations each able to transmit and receive data over the primary network, a plurality of bridge stations able to transmit and receive data both over the primary network and over the auxiliary network, and a plurality of auxiliary stations each able to transmit and receive data over the auxiliary network, the communication network being operable to transmit message data from an originating station to a destination station via at least one opportunistically selected intermediate station, the method including:
monitoring, at each of a plurality of bridge stations, the activity of other stations on both the primary network and the auxiliary network to establish the availability of intermediate stations for onward transmission of message data from the originating station to the destination station;
transmitting via the auxiliary network, from said at least one bridge station, probe signals to stations on the auxiliary network, the probe signals being addressed to at least one station on the auxiliary network;
transmitting, from stations on the auxiliary network receiving probe signals from said at least one bridge station, response signals including connectivity data, thereby to identify at least one station on the auxiliary network available as an intermediate station for onward transmission of the message data to the destination station; and
transmitting message data from the originating station to the destination station via at least one opportunistically selected intermediate station, including at least one bridge station.

The method according to the first aspect of the invention may include including transmitting via the primary network, from said at least one bridge station and from primary stations, probe signals to other primary stations, primary stations receiving the probe signals responding by transmitting connectivity data to indicate their availability as intermediate stations.

According to a second aspect of the invention there is provided a method of operating a communication network comprising a primary network and an auxiliary network, including a plurality of primary stations each able to transmit and receive data over the primary network, a plurality of bridge stations able to transmit and receive data both over the primary network and over an auxiliary network, and a plurality of auxiliary stations each able to transmit and receive data over the auxiliary network, the communication network being operable to transmit message data from an originating station to a destination station via at least one opportunistically selected intermediate station, the method including:
monitoring, at each of a plurality of primary stations and bridge stations, the activity of other stations on the primary network to establish the availability of intermediate stations for onward transmission of message data from the originating station to the destination station, the intermediate stations including bridge stations;
transmitting via the primary network, from a station on the primary network with message data to transmit from the originating station to the destination station, probe signals to other stations on the primary network including at least one bridge station, thereby to identify at least one bridge station available as an intermediate station for onward transmission of the message data to the destination station; and
transmitting message data opportunistically, from said station on the primary network with data to transmit and via said at least one bridge station, to the destination station.

The method according to the second aspect of the invention may include transmitting via the auxiliary network, from said at least one bridge station, probe signals to stations on the auxiliary network via the auxiliary network, the probe signals being addressed to at least one station on the auxiliary network, thereby to identify at least one station on the auxiliary network available as an intermediate station for onward transmission of the message data to the destination station.

In either case, the method may include maintaining, at each bridge station, a neighbor table containing details of, and connectivity data relating to the availability of, primary stations and stations on the auxiliary network as destination or intermediate stations.

The method may include transmitting, from an auxiliary station with message data to transmit from the originating station to the destination station, probe signals to other stations on the auxiliary network, the probe signals being addressed to at least one station on the auxiliary network, thereby to identify at least one station on the auxiliary network available as an intermediate station for onward transmission of the message data to the destination station.

The method may further include maintaining, at each auxiliary station, a neighbor table containing details of, and connectivity data relating to the availability of, auxiliary stations and bridge stations as destination or intermediate stations.

Preferably, initial probe signals are addressed to one or more stations on the auxiliary network identified in data received from another station, or from an authentication station storing connectivity data relating to stations on the network, in order to identify one or more potential neighbor stations with good connectivity to the station transmitting the probe signals.

Stations on the auxiliary network may transmit probe signals to other stations on the auxiliary network from time to time in order to maintain a group of neighboring stations with good connectivity to such probing stations for potential future use as intermediate stations.

In one embodiment of the invention, the primary network includes a wireless network and the primary stations include wireless stations.

In the above mentioned embodiment, he originating station may be a wireless station and the destination station may be an auxiliary station or bridge station on the auxiliary network.

Alternatively, for example, both the originating station and the destination station may be wireless stations, the method including transmitting probe signals via a station on the auxiliary network to at least one further bridge station and from said at least one further bridge station to at least one further wireless station, and transmitting message data opportunistically from said station on the auxiliary network and from said at least one further bridge station to the wireless destination station.

In a preferred embodiment of the method, the originating and destination stations maintain peer-to-peer connectivity via the auxiliary network.

The probe signals may include neighbor gathering probe signals, stations receiving neighbour gathering probe signals from other stations responding by transmitting connectivity data to indicate their availability as intermediate stations.

The probe signals may include gradient gathering probe signals, stations receiving gradient gathering probe signals from other stations responding by transmitting cost gradient data indicating the cumulative cost of communication between the stations.

In one embodiment of the method, the primary network and the auxiliary network utilize different transmission media, and characteristics of the connectivity data and/or the cost gradient data are modified according to the characteristics of the primary network and the auxiliary network, depending on whether the station transmitting said data is a station on the primary network or the auxiliary network.

The cost gradient data may be based on one or more cost functions determined from the time delay, data rate and packet loss experienced in message transmission between different stations and/or one or more cost functions determined from the relative load and resources available at each station.

The method may include transmitting, from each station, authentication messages to an authentication station, the authentication station operating to authenticate stations on the communication network from time to time and to store data relating to the connectivity of stations amongst themselves and with other intermediate stations including bridge stations, thereby enabling the neighbor gathering probe signals to be transmitted opportunistically between each station and selected bridge stations, or according to stored connectivity data provided by another station or by the authentication station.

Preferably the stations interact with said authentication station to maintain a record at the authentication station of bridge stations available to each station as intermediate stations from time to time.

Some or all of the record maintenance may be distributed by the authentication station through other stations in the communication network, effectively defining a distributed authentication station.

The stations may be wireless stations that communicate with said authentication station and/or distributed authentication station via at least one bridge station.

The stations may be wireless stations that transmit connectivity data relating to the availability to said wireless stations of bridge stations as intermediate stations when transmitting authentication data to said authentication station and/or distributed authentication station.

Gradient gathering probe signals transmitted via said selected bridge stations to said at least one other bridge station may be addressed to bridge stations identified by the authentication station and/or distributed authentication station, or by other network stations, as having connectivity to the destination station, directly or via one or more intermediate stations.

Preferably, said selected bridge stations continue to address the gradient gathering probe signals to bridge stations previously identified by other stations as having had connectivity to the destination station, directly or via one or more intermediate stations, in order to maintain said previously identified bridge stations available as potential intermediate stations even when not required immediately as intermediate stations.

The gradient gathering probe signals may be sent at predetermined probing intervals to said previously identified bridge stations until a connection is no longer required between the originating and destination stations.

In a preferred embodiment of the invention, the gradient gathering probe signals are sent as standard packet formats comprising ODMA data packets that define the probe signal characteristics.

Preferably, the gradient gathering probe signals are sent as UDP datagram packets comprising ODMA data packets.

The gradient gathering probe signals may contain cost function information on the cumulative cost of message transmission between stations having connectivity with one another, directly or via intermediate stations, for both primary stations and stations on the auxiliary network.

The primary network and the auxiliary network may utilize different transmission media, the cost function information being calculated by appropriate weighting of the costs determined in the primary and auxiliary media, thereby ensuring that an optimal message transmission route is followed irrespective of the medium used to transmit the message data.

In one embodiment of the method, at least one gateway station on the auxiliary network has connectivity to an external network, said at least one gateway station having means for storing addresses of stations on the primary network and mapping them to addresses on the external network.

According to a third aspect of the invention there is provided a communication network, comprising a primary network and an auxiliary network, for transmitting message data from an originating station to a destination station via at least one opportunistically selected intermediate station, the communication network including:
a plurality of bridge stations, each bridge station being able to transmit and receive data both over the primary network and over the auxiliary network, and being operable to monitor the activity of other stations on the primary network and on the auxiliary network, to establish the availability of stations on the primary network or the auxiliary network as intermediate stations for onward transmission of message data from the originating station to the destination station; and
a plurality of primary stations, each primary station being able to transmit and receive data over the primary network and being operable to monitor the activity of other stations on the primary network, to establish the availability of other primary stations or bridge stations as intermediate stations for onward transmission of message data from the originating station to the destination station,
   each primary station with message data to transmit from the originating station to the destination station being operable to transmit, via the primary network, probe signals to other stations on the primary network including at least one bridge station, in order to identify at least one bridge station available as an intermediate station for onward transmission of the message data to the destination station, thereby to transmit message data opportunistically, from said primary station with data to transmit and via said at least one bridge station, to the destination station.

The communication network according to the third aspect of the invention may include a plurality of auxiliary stations each able to transmit and receive data over the auxiliary network, each bridge station being operable to transmit probe signals to stations on the auxiliary network, the probe signals being addressed to at least one station on the auxiliary network, thereby to identify at least one station on the auxiliary network available as an intermediate station for onward transmission of the message data to the destination station.

According to a fourth aspect of the invention there is provided a communication network, comprising a primary network and an auxiliary network, for transmitting message data from an originating station to a destination station via at least one opportunistically selected intermediate station, the communication network including:
a plurality of bridge stations, each bridge station being able to transmit and receive data both over the primary network and over the auxiliary network, and being operable to monitor the activity of other stations on the primary network and on the auxiliary network, to establish the availability of stations on the primary network or the auxiliary network as intermediate stations for onward transmission of message data from the originating station to the destination station; and
a plurality of auxiliary stations, each auxiliary station being able to transmit and receive data over the auxiliary network and being operable to monitor the activity of other stations on the auxiliary network, to establish the availability of other auxiliary stations or bridge stations as intermediate stations for onward transmission of message data from the originating station to the destination station,
   each auxiliary station with message data to transmit from the originating station to the destination station being operable to transmit, via the auxiliary network, probe signals to other stations on the auxiliary network including at least one bridge station, in order to identify at least one bridge station available as an intermediate station for onward transmission of the message data to the destination station, thereby to transmit message data opportunistically, from said auxiliary station with data to transmit and via said at least one bridge station, to the destination station.

The communication network according to the fourth aspect of the invention may include a plurality of primary stations each able to transmit and receive data over the primary network, each bridge station being operable to transmit probe signals to stations on the primary network, the probe signals being addressed to at least one station on the primary network, thereby to identify at least one station on the primary network available as an intermediate station for onward transmission of the message data to the destination station.

The communication network may include at least one authentication station arranged to authenticate stations on the communication network from time to time and to store data relating to the connectivity of stations amongst themselves and with intermediate stations including bridge stations, thereby enabling probe signals to be transmitted opportunistically between each station and selected bridge stations, or according to stored connectivity data provided by another station or by the authentication station.

The communication network may include at least one gateway station on the auxiliary network with connectivity to an external network, said at least one gateway station having means for storing addresses of stations on the primary network and mapping them to addresses on the external network.

The external network may be the Internet and the gateway station may store a directory table in which addresses of stations on the primary network are mapped to Internet addresses.

Alternatively the external network may a telephony network and the gateway station may store a directory table in which addresses of stations on the primary network are mapped to telephone numbers on the telephony network.

### BRIEF DESCRIPTION OF THE DRAWINGS

FIG. 1(a) is a schematic connectivity diagram of a wide area network according to the present invention showing the integration of mobile and wired networks and the use of different types of network stations;

FIG. 1(b) is a connectivity diagram of a network similar to that of FIG. 1(a) showing the incorporation of a packet switched auxiliary network comprising satellites;

FIG. 2 is a schematic connectivity diagram illustrating the operation of the network of FIG. 1 in use;

FIG. 3 is a schematic diagram illustrating the operation of a network according to the invention in the case of a mobile client station moving through different portions of the network;

FIG. 4 is a simplified schematic diagram illustrating the routing of message data between an originating station and a destination station in the network of the invention;

FIG. 5 is a similar diagram to that of FIG. 4 showing a more complex routing example;

FIG. 6 is a similar diagram to that of FIGS. 4 and 5, showing the establishment of cost functions in the routing process;

FIG. 7 is a similar diagram to that of FIGS. 4 to 6, showing a further example of routing in the network of the invention in which message data packets are sent via different routes determined by the cost function towards the destination station; and

FIGS. 8 to 13 are simplified block schematic diagrams of the major hardware components of various different types of station making up the network.

### DESCRIPTION OF EMBODIMENTS

The present invention relates to an Opportunity Driven Multiple Access (ODMA) communication network of the general kind described in WO 96/19887 entitled Multi-Hop Packet Radio Networks, the contents of which are incorporated herein by reference. In particular, the present invention relates to the implementation of such a network over a wide area, such as in a regional, national or global network, by integrating a wireless ODMA network with one or more auxiliary packet switched networks using adapted forms of ODMA techniques. The auxiliary network could comprise conventional wired networks, such as Ethernet networks and the Internet, as well as “virtual” wired networks, such as the network created using satellite nodes, or any combination of these networks.

An important component of the communication network of the invention is true peer-to-peer connectivity between a large number of moving ODMA client stations, whether they are proximally close together or in different countries. Such peer-to-peer connectivity is offered over an auxiliary network (typically the Internet) which can use a different transmission medium from the mobile ODMA stations.

Several actual “wired” and virtual “wired” packet switched media are available for use in such a “global network”. The most relevant of these media is the Internet and this is discussed in great detail in this document in describing the embodiments of the invention. However, there are several major difficulties that must be addressed in routing data through the Internet using ODMA protocols, or indeed over “wire” in general, not least of which is the potential for congestion over the actual or virtual wired medium. Even more problematic is the complexity caused by the communicating wireless client stations being mobile relative to one another and to the access points of the auxiliary network. This presents difficulties regarding the manner in which any mobile destination station is located from the potentially huge number of moving stations available on a global ODMA network at any given time (which could be in the order of hundreds of millions or more).

If there are only a few access points to the auxiliary network then the solution would be relatively trivial. However, in such a solution, if only a few wired pathways were available these would likely become saturated and effectively form bottlenecks to connectivity. Were certain access points to fail and lose connectivity, other access points that might have been available (if any) would become even more congested and the connectivity results for the mobile client stations relying on the access points could be catastrophic.

To make the overall network connectivity more resilient, the mobile client stations should have many potential access points to the auxiliary network. Ideally, data transmissions should be routed through the most suitable wireless or wired media available at the moment the transmission is being sent onward, using ODMA protocols. To achieve this ideal, the location of the access points with optimal connectivity to the other wireless stations must be known with some certainty at any given time and this information must be refreshed on an ongoing basis due to the movement of the wireless stations. However, the manner in which stations are located must also be achieved without overburdening the auxiliary network medium with unnecessary probing transmissions.

In addition, the access points should be easily installed and configured. Consequently, most access points are likely to be unsophisticated and undedicated units that are automatically set up and configured through the network. Ultimately, when one user station attempts to communicate with another, the objectives are to locate quickly the destination station from the very large number of mobile users on the network; to provide secure, reliable communications over the network fairly; and to optimize the capacity and quality of the data services provided on an as-needed basis.

This document describes the topology of a wide area (“global”) ODMA network for data and/or voice communication which addresses the complexities described above in order to provide an ODMA network that is scalable to many millions of client stations. It also describes the multi-medium ODMA architecture necessary to implement the network and the component devices necessary to build the global network.

### Overview of Network Topology

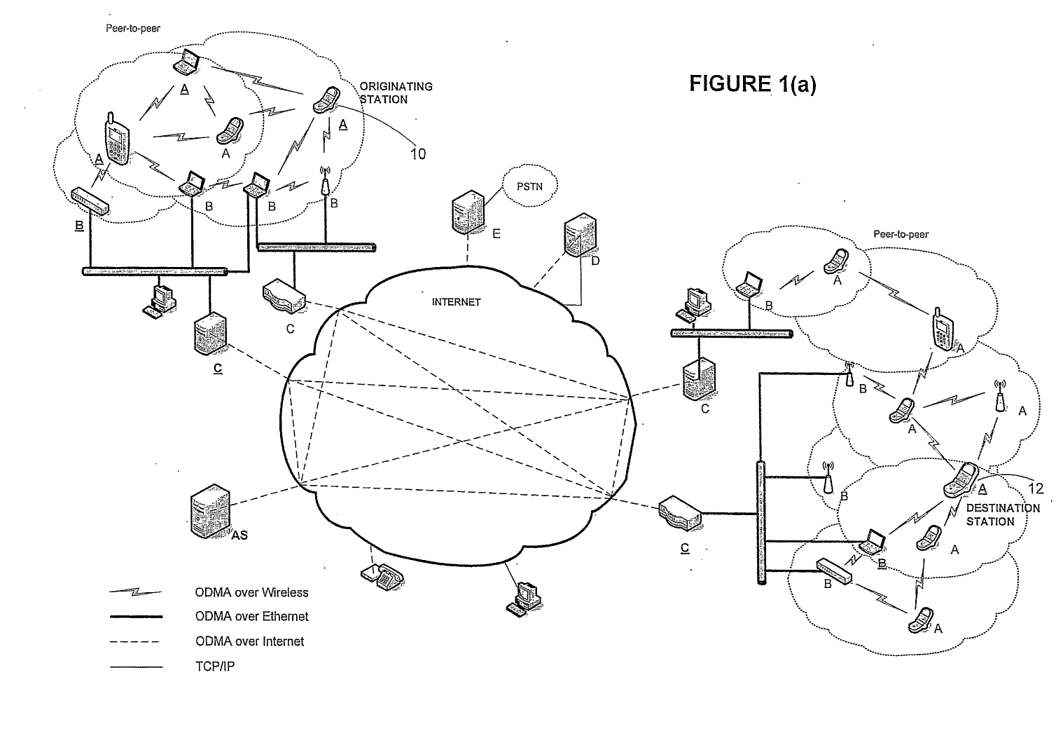

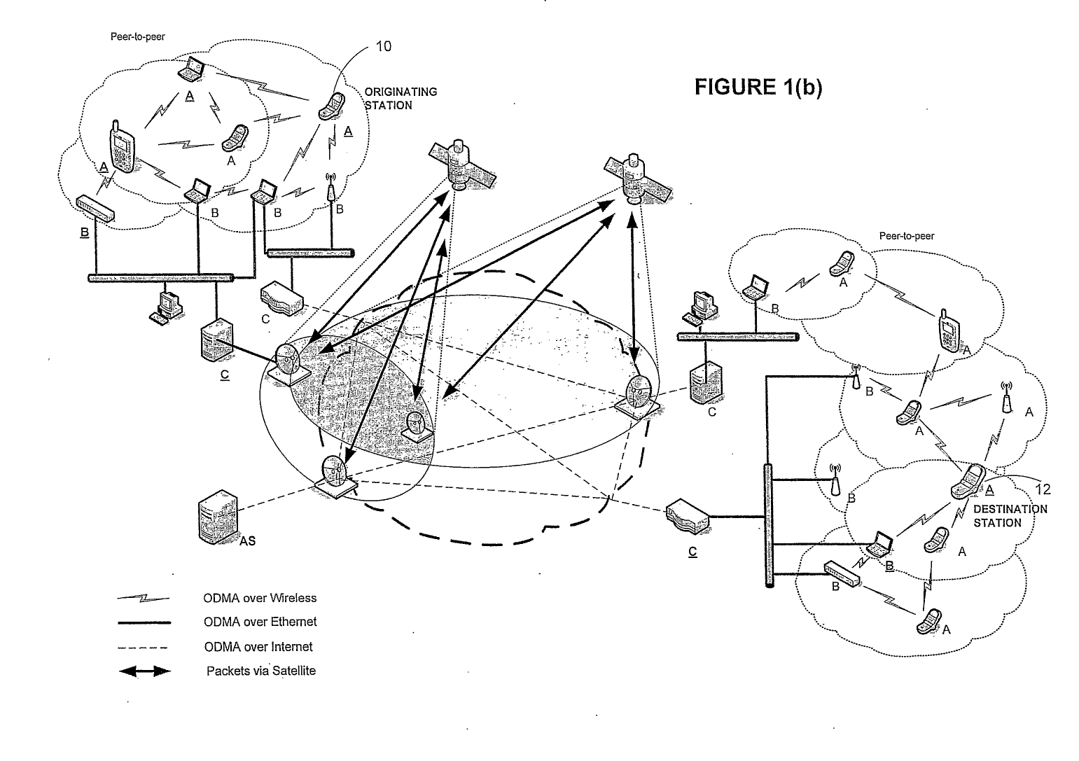

FIG. 1(a) shows the topology of the wide area network of the invention in a simplified schematic form. In the diagram, message data is transmitted from one mobile, wireless client station (the originating station) to another (the destination station) over a multi-medium ODMA network. The message data is transmitted first over a wireless medium by the originating station, then over a wired medium (over one or more Ethernet networks and the Internet) before finally being transmitted again through a wireless medium to the destination station. One potential route (through the stations underlined) from the originating station to the destination station is illustrated, although it will be appreciated that a number of alternative routes could have been followed in the network. FIG. 1(b) shows a similar topology to that illustrated in FIG. 1(a), where satellites provide a virtual “wired” medium to replace or supplement a conventional wired auxiliary network such as the Internet.

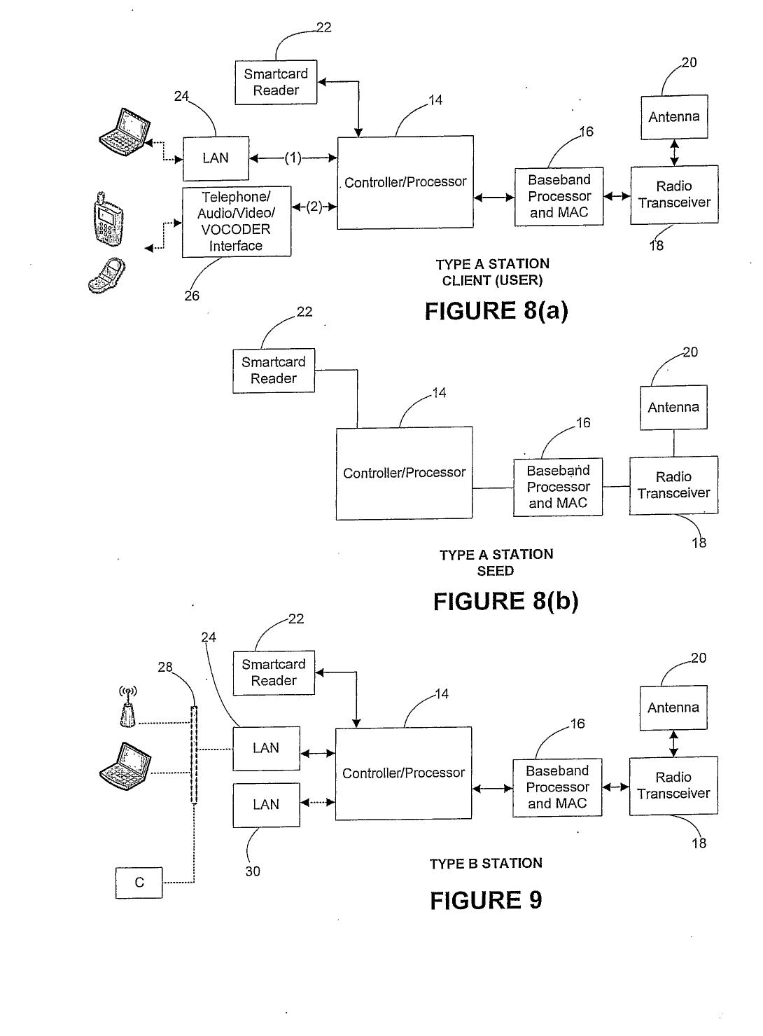

Various hardware devices are required to build the network and these are labeled as stations of type A to E in FIG. 1. Simplified block schematic diagrams of the different types of stations are shown in FIGS. 8 to 13.

### Type A Stations—Wireless Client Stations and Wireless Seeds

Wireless client (user) stations are generally mobile wireless radio transceivers that communicate with other wireless client stations and wireless seed stations (which are typically fixed) using ODMA over Wireless. Wireless client stations typically have either an Ethernet interface that enables an associated computing device to receive and transmit data (using standard TCP/IP or similar protocols) through the unit, or have connectivity to mobile telephone hardware to enable voice data transfer. The type A stations communicate between themselves using ODMA over Wireless connectivity.

FIG. 8(a) shows the major components of a typical type A wireless client station. The station comprises a main microcontroller/microprocessor 14, and a baseband processor and MAC circuit 16 connected to a radio transceiver circuit 18 having a suitable antenna 20. Connected to inputs of the microcontroller 14 are a smartcard reader 22 for reading secure smartcard “tokens” of authorized users of the client station, and optionally a LAN interface card 24 for interfacing the station to an Ethernet network, and/or an audio/video/Vocoder interface 26 for connecting the station to a user device such as a mobile telephone, a conventional telephone or a video input/output device.

A detailed description of the basic circuits of a type A client station is given in International patent application no. PCT/IB2004/004111 entitled Probing Method for a Multi-Station Network, the contents of which are incorporated herein by reference.

Wireless seed stations are similar to the wireless client stations, providing additional wireless coverage by acting as intermediate stations for use by the wireless client stations in communicating with each other. However, the seed stations generally do not have any other connections or interfaces as in the case of the wireless client stations. Wireless seed stations are typically stationary, fixed installations, possibly having specialized antennas. However, these stations could also be mobile and could be mounted on a motor vehicle or a train, for example. The major components of a typical wireless seed station are shown in FIG. 8(b).

### Type B Stations—ODMA Wireless to Ethernet Adapters

The wireless to Ethernet adapters are similar to the wireless client stations and wireless seed stations, but these units have the added capability of being linked together via an Ethernet backbone or sub-network 28 using ODMA protocols due to the provision of an ODMA Ethernet interface 30. These devices support both ODMA over Wireless and ODMA over Ethernet. The adapters are typically used to create a cluster of wireless access points to increase throughput near an Internet connection point, or perhaps to join several such devices together over a large office Ethernet network. The Ethernet connection will usually be connected in a wired network with several other Wireless to Ethernet adapters and a type C Ethernet to Internet adapter (see below). The type B stations may be located physically remote from the type C stations (see below), and the Ethernet connections to the type B stations may be via regular cabling, or through high capacity microwave links, fiber-optic cabling or the like as required.

The major components of a typical type B station are shown in the block diagram of FIG. 9. The station is similar to a type A station but the LAN interface card 24 is connected to an ODMA enabled Ethernet. The station may optionally include other LAN interface cards 30.

### Type C Stations—Ethernet to Internet Adapters

These devices provide a bridge or gateway between an ODMA over Ethernet network 28 and the Internet 32 at large and will have a fixed or dynamic Internet (IP) address on the Internet. Each device will maintain a cache of data identifying other type C ODMA over Internet devices that the unit has established are present on the Internet, and is able to locate such other devices by making requests to one or more Authentication and Directory Servers (see below). If the type C station has a dynamic address then the Authentication Server will have to keep track of the type C station by matching the station with its ODMA address.

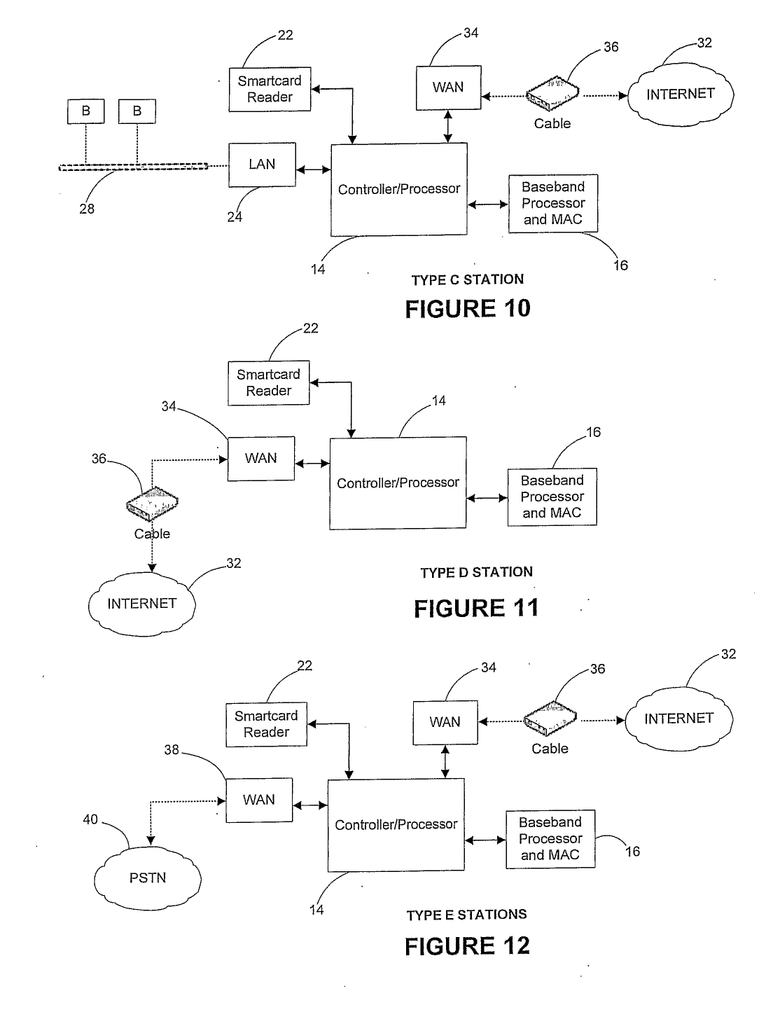

FIG. 10 shows the major components of a typical type C bridge station. The core components of the type C station are the same as for the type A and B stations, but there is typically no wireless connectivity. Instead, a WAN interface 34 (typically a cable modem) and a wired or cable connection 36 to the Internet 32 are provided. An ODMA Ethernet interface 24 connects the station to an ODMA over Ethernet sub-network 28.

Although the type C bridge stations are described and illustrated herein as having connectivity to the ODMA wireless network via an intermediate Ethernet network, for the reason of increasing network throughput near an Internet access point as mentioned above, the type C stations could have direct wireless connectivity instead, or in addition to Ethernet connectivity.

### Type D Stations—Internet to TCP/IP Adapters

The major components of a typical type D station are shown schematically in FIG. 11. These devices are connected to the Internet 32 in the same way as the type C bridge stations and translate/convert data between an ODMA over Internet protocol and standard TCP/IP. These devices act as bridges or gateways between the TCP/IP Internet at large (the “real Internet,” where standard Internet services and applications are available) and the wide area ODMA network. Obviously many of these devices may be required and their existence and load will be monitored by the Authentication and Directory Servers. Incoming traffic for TCP/IP servers on the ODMA network will be forwarded to the relevant ODMA access point. These stations are placed in locations enjoying high connectivity with the Internet, but in theory they could all be placed in any one location, or in many locations around the world depending on the load requirements and the flexibility required.

### Type E Stations—Internet to PSTN Adapters

These devices serve as adapters or gateways to translate/convert between ODMA over Internet and the Public Switched Telephone Network (PSTN) for “real” telephony applications. The adapters are used to connect ODMA voice data traffic into such telephone networks and use standard PSTN protocols. These stations must be placed in many locations around the world to where the ODMA network extends, if local call rates in the regions dialed are desirable. The devices do not necessarily require a connection to the Internet (as shown in FIG. 1), as the main function of the devices is the translation/conversion of ODMA data into data recognized by the PSTN. Ultimately, the only requirement is that the units be placed where there is sufficient capacity (which could be a B type station for example). However, the likelihood is that the Internet will be preferred as the point of connectivity, as there is typically a consistently high capacity through this medium.

FIG. 12 shows the major components of a typical type E station, which are substantially similar to those of a type D station, but with the addition of a further WAN interface 38 providing connectivity to a PSTN network 40.

### Type AS Stations—Authentication and Directory Servers

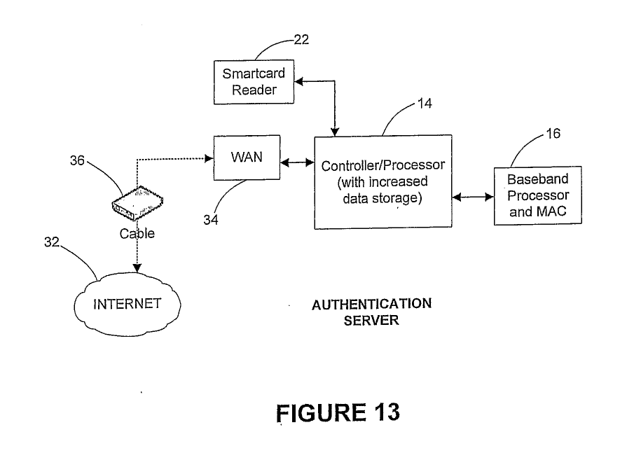

The basic layout of the major components of a typical Authentication Server (or authentication station) is shown schematically in FIG. 13. As with the other stations, the Authentication Server includes a main processor 14 (but having increased data storage compared with the other stations) and a baseband processor and MAC circuit 16. The Authentication Server includes a WAN interface 38 such as a cable modem to interface with the Internet 32, similarly to the type D and E stations.

These servers, which might be replicated geographically, are used in the wide area ODMA network to authenticate all of the ODMA devices available on the network. The Authentication Server may then locate devices on the network and may act as a directory in certain applications, such as in voice networks where the Authentication Server can handle phone number to ODMA device translation, or it may facilitate subscriber billing and management, etc. If replicated, the different Authentication Servers on the network would communicate with each other in order to ensure that the information available at any server is up to date at any given time. There are many ways of achieving this status—for example, the servers could all duplicate the available information; the servers could hold only certain categories of information (e.g. based on station type, or the ODMA address to application address information, etc); or the servers could be hierarchical, regional etc.

Provided that each server has current information regarding where and how the information may be accessed from the other servers, then the actual number of servers and the nature of the information retained by each server is not relevant. At least one Authentication Server must have a fixed address, so that the other Authentication Servers having dynamic addresses on the system can be located. These servers consequently perform several functions:
Authenticating ODMA stations on a regular basis.
Retaining and disseminating knowledge of the whereabouts of all stations on the network (including knowledge of which type C stations have connectivity with every type A station, together with details of the quality of the connectivity).
Maintaining maps and disseminating information, such as Internet address-to-ODMA address information for fixed Internet addresses on the ODMA network (servers, etc) and/or other application addresses corresponding to the ODMA units.
Retaining and disseminating knowledge of all Ethernet to Internet, Internet to TCP/IP, Internet to PSTN adapters and similar devices.
Performing subscriber management, security, authentication and billing applications, etc.

Communication between Authentication Server stations and type C stations would be via a mechanism such as ODMA over Internet.

Thus, it can be seen that the wide area ODMA network described above comprises essentially two main component networks, being a primary, wireless network with an associated optional Ethernet sub-network, and a secondary, auxiliary packet switched network, typically the Internet. Connected to the wide area network via the auxiliary network are a PSTN telephony network and the “Internet at large” utilizing TCP/IP. Connected to both the primary and auxiliary networks are the type C bridge stations. The functioning of the various aspects of the wide area ODMA network and its components is described in greater detail below.

Referring to FIG. 1, it should be appreciated that the originating type A station 10 and its various type A and B ODMA neighbors that it has gathered may have multiple forms of communication available to them. The originating station 10 and the destination station 12 are illustrated as having only wireless connectivity, as this is the primary difficulty being addressed in the present instance—namely the complexity involved when a station (one of many millions of possible stations) has mobility relative to Internet access points (of which there are many). The neighbors that are gathered near the originating station may have multiple forms of connectivity available to them that enable the transmission of data through the different media—for example a neighbor station could be a laptop computer that is simultaneously connected through Ethernet to a local area network (LAN), to the Internet (via a modem or ADSL etc. connection), as well as having an active wireless card enabling wireless ODMA communication. In other words, such a station could incorporate the functions of stations of types A, B and C all in a single unit and could have neighbors with similar or lesser functionality through which data may be routed on behalf of the originating station as required. However, the neighbors will typically be either A type stations or B type stations.

As the potential connectivity of the originating station 10 changes, especially if the station moves around, the “cloud” of neighbors that are accessible to it, and which provide the access to the ODMA network for the station 10, will change in order to route any data transmissions through the most efficient series of stations possible. It will also be appreciated that any A type stations in the cloud formations illustrated have true peer-to-peer wireless connectivity with all of the stations (of any type) on the wide area ODMA network of the invention.

It should be apparent that the Authentication Server need not necessarily be directly connected to the auxiliary network as such. The Authentication Server could be located in an area with wireless connectivity. This is especially relevant in two circumstances. Firstly, areas having poor connectivity to the auxiliary network, or indeed areas that are completely isolated from the rest of the global network, will still require communication locally. The provision of a wireless local Authentication Server addresses the needs of emergency services, for example, where police, ambulance and fire brigade personnel cannot afford a complete collapse of the communication network—at least locally. Similarly, regions or countries with limited access to the auxiliary network may have reduced global network coverage, but will enjoy sufficient performance on a regional basis.

The second situation is in areas of high concentration or connectivity, such as at airports and sports stadiums. A situation in which large numbers of stations simultaneously attempt to communicate with an Authentication Server accessible only on the auxiliary network has the potential to overload the access points. A wireless Authentication Server in the area of high concentration would address this problem, which would communicate with the Authentication Server located on the auxiliary medium. The decentralization and distribution of authentication and directory functionality is discussed in greater detail below.

### Multi-Medium Architecture

Various devices in the wide area communication network may be required to handle more than one disparate communications medium in order to communicate from originating station to destination station using the ODMA protocols. Since the characteristics of the various media vary greatly, different protocols and algorithms are adopted to handle the processing of the data transmission through each medium.

In particular, each medium (e.g. wireless, Ethernet and Internet, etc.) with its corresponding protocols (ODMA over Wireless, ODMA over Ethernet, ODMA over Internet, etc.) supported by a device has its own neighbor table and associated parameters which are of relevance to the medium. Slow and fast probing is done separately in each medium as appropriate, depending on the parameters that are relevant for that medium. However, briefly stated, the objective of slow probing is ultimately neighbor gathering, or the gathering of information relating to the quality of connectivity between stations, while the objective of fast probing is the provision of gradient information, as described in more detail below.

The gradient table constructed from originating station to destination station is common to all the various media, regardless of which media are utilized, and the gradients identified would be based on all the relevant neighbor information through each medium. Consequently, it should be evident that the gradient table is independent of any medium through which the data is actually subsequently transmitted.

For example, the ODMA to Ethernet devices mentioned above (B type stations) have both wireless connectivity and Ethernet connectivity. Both media use ODMA protocols, but the relevant information gathered, processed and communicated differs considerably, as do the factors applied in the routing algorithms. In the Ethernet medium neighbors are created immediately and the stations on an Ethernet network that are capable of providing Internet access are readily apparent to all the other Ethernet stations. There is no path loss in this medium and hence all neighbors have the same low cost. There are also no power-control aspects to consider and throughput is (potentially) high.

However, the Ethernet medium is similar to the wireless medium in the sense that it is a shared medium where broadcasting to the stations using that medium is possible. In an Ethernet medium data transmissions from one station propagate everywhere on the relevant network segment. Each station selects frames of data meant for it by inspecting the addresses in all frames transmitted on the segment, then decoding and reading the relevant packets transmitted (although it is also possible to target particular stations for a response). Slow probing could be relatively slow in an Ethernet medium since the neighborhood is potentially large and stable. However, the basic principles in this respect are similar to the methodologies applied over a wireless medium. In the Ethernet medium, therefore, the relative loads of the devices (how busy they are) could be used as a more appropriate indicator of the cost function if necessary.

The methodologies involved in identifying and gathering neighbor stations in the Internet medium are explained in greater detail below, but whatever the media utilized in the data transmission, the neighbors will operate collaboratively and track their relative strengths of connectivity. Neighbors with large buffer contents, for example, will represent a large cost function and so load would be shed to neighbors having better capacity if this is possible—based on factors that are available from information provided in the packets being transmitted, such as the priority of the packet transmission, the time to live and size of the packets etc.

However, in a multi-medium network it is important to ensure that the cost functions used to route the data transmission through the various media are compatible, to ensure that the optimal route is followed—for example, higher capacity media will have a lower cost factor applied, etc. This is achieved by applying an appropriate weighting against the costs determined in the different media, thereby providing relative costs that are comparable over the various potential media.

In general, costs are determined as integers with each hop over the wireless medium usually having a cost function allocated at the least cost (1). The Ethernet medium functions in a similar manner to the wireless medium and usually the cost function in this medium is also assigned a cost of 1. The Internet medium will typically be allocated a cost between 1 and 5 depending on the factors identified. The cumulative cost function is simply the aggregate of the cost functions associated with the transmission of data from originating to destination station, and this equates to the gradient defined.

The cost functions that apply to the different types of message data to be transmitted may vary. For example a higher weighting could be applied to certain factors depending on whether the data is time dependent (e.g. in the case of voice data which generally requires short delays). While the costs are added together to define the gradient table information in respect of the neighbors at any given moment in time, the types of costs could be distinguished and specified in different fields in the ODMA packets (e.g. the particular gradient from a station to the destination could carry a cumulative cost function of 11; or it could be stated as 5 wireless plus 3 wire plus 3 wireless; or as 8 wireless plus 3 wire, etc). This may be useful in certain applications to enable better decision making, but the processing of the gradients is correspondingly more complicated.

### Transport Protocols

The global ODMA network utilizes a number of transport protocols. Packet protocols of various types may be “encapsulated” in other packet protocols. Headers are added to the encapsulated packets and once the data is transported over the medium, the encapsulated packets are removed from the protocol and the headers are stripped away. More detail on these protocols is provided below.

When two computers are connected to each other, or where a computer is connected to the “real” Internet (i.e. for browsing purposes), the communication is typically carried out using TCP/IP. The TCP/IP packets can be placed in other packets, such as Ethernet packets if transported in the Ethernet media, or placed in ODMA packets if transported across the ODMA network. However, the ODMA network can make use of both the wireless and the “wired” media—if in the wired medium, ODMA packets may be transported in UDP packets over the Internet, or in Ethernet packets if transported over an Ethernet network. Security can be provided at the different levels of transport if required, there being no strict hierarchy in this respect. Typically, ODMA packets are encrypted at the source station prior to encapsulation into the other packets and then unencrypted at the destination. However, the packets transporting the ODMA packets could optionally be encrypted as well if required.

ODMA over Wireless

Concisely, the ODMA over wireless methodology is used in a communication network which has a number of wireless stations which are able to transmit data to and receive data from one another. The methodology comprises defining a first probing channel for the transmission of first, broadcast probe signals to other stations. Other stations which receive the first probe signals (also referred to as slow probes) from a probing station indicate to the probing station their availability as destination or intermediate stations. A neighbor table comprising details of, and connectivity data relating to, these other available stations is maintained at each station. Thus, the broadcast slow probe signals are effectively neighbor gathering probe signals.

In a wireless medium, when there are a number of stations in close proximity they will end up probing at higher data rates and low transmit powers. Stations will occasionally respond to stations that are on probing at the lower data rates or that do not have enough neighbors to help any lonely (distant) stations (also referred to below as lonely neighbors) that cannot use the higher data rates or do not have sufficient neighbors. Stations will only use the lower data rates when they are lonely and cannot find sufficient neighbors at the higher data rates and at maximum power.

Each station will transmit slow probe signals at regular intervals (determined by a Slow Probe Timer) trying to find other stations. Stations indicate in their slow probes that they are able to detect other stations probing and in that way stations will vary their probe power until a certain predetermined number of stations indicate they are able to detect the probes. If a station never acquires the required number of neighbors it will remain at the lowest data rate and maximum transmit power.

Each station will randomly vary the Slow Probe Timer slightly between slow probe signal transmissions to avoid collision with other stations. Should any station start receiving another station's transmission, it will reload the Slow Probe Timer with a new interval.

In a wireless network of mobile stations the stations are constantly moving, and as such the number of neighbors will constantly be changing. If the number of neighbors exceeds the required number a station will start to increase its data rate on the probing channel. It will continue to increase its data rate until it no longer exceeds the required number of neighbors. If it reaches the maximum data rate it will start to drop its slow probe transmit power by small increments until it either reaches the minimum transmit power, or no longer exceeds the required number of neighbors.

When a station replies to another station's slow probe on a Probing Channel it will limit the length of its data packet to the Slow Probe Timer interval. This is to avoid other stations probing over its reply. If the station that is replying has more data to send than will fit in a small packet it will indicate in the header of the packet that the other station must move to a specific Data Channel.

There can be a number of Data Channels defined for each Probing Channel. The station that is requesting the change will randomly select one of the available Data Channels. When the other station receives the request it will immediately change to that Data Channel, where the two stations will continue to communicate until neither of them have any data to send, or if the maximum time for remaining on the Data Channel expires (set by a Data Timer). Alternative data transport protocols could also be used.

When a station changes to the Data Channel it loads the Data Timer. It will remain on the Data Channel for as long as the Data Timer will allow. When the Data Timer expires the stations will revert back to the Probing Channel and start probing again.

The slow probing process consists of three basic functions:

1. Neighbor collection
2. Power learning
3. Ramping of neighbors

The process of neighbor collection consists of a station probing at increased levels of power until neighboring stations indicate in their own probes that they are detecting the probes of the first station. This is called neighbor collection. The power of the probe is increased until a predetermined number of neighbors indicate that they are detecting the probes.

All probing stations increase and decrease their probe power until all stations have collected a predetermined number of neighbors. This process consists of increasing and decreasing the power level of probes and indicating in probes which other stations' probes are heard. In this way all stations can learn what power level they require to reach various neighbors.

Each time a station probes it indicates its transmit power and noise floor and which stations it has as neighbors. Every time a station hears another station probe it calculates from the probe the path loss and power required to reach the station from the path loss and the noise floor of that station. The path loss to the neighbor and the power required to reach the neighbor is stored in a table kept at each station called a neighbor table. If a neighbor is no longer heard then the path loss and power level required to reach the station is increased or “ramped” in the table until a certain level is reached at which point the neighbor is removed from the neighbor table

Also, second probe signals (fast probes) are sent and received from stations in the neighbor table and a gradient table comprising data related to the cost of communicating with each neighbor station is maintained at each station. The neighbor table allows each station to select a predetermined number of intermediate stations for onward transmission of data from an originating station to a destination station at minimum cost.

Thus, the fast probe signals are effectively gradient gathering probe signals.

If a station has a message for a destination that is not one of its neighbors, for example, a distant station across the network, it begins to transmit fast probe signals to develop information on how to reach the destination. The information is called a gradient and is an indication of the cumulative cost to reach a destination. When a station starts to fast probe it indicates that it is looking for a destination and neighbors hearing the fast probe will fast probe themselves until the destination hears the fast probes of its neighbors. The gradient is then built through adding cumulative cost until the gradient reaches the source, and the source can commence to send messages to neighbors that have lower gradients to destination, which in turn can send them to their neighbors until the destination is reached.

The cost gradient data will typically be based on one or more cost functions determined from the time delay, data rate and packet loss experienced in message transmission between different stations and/or one or more cost functions determined from the relative load and resources available at each station.

Each station keeps a record of the (cumulative cost) gradients to each destination of each of its neighbors, and its own gradient to the destination, in the form of a gradient table. Each station only passes messages to stations with a lower cumulative cost to destination. A station can pass a message to any of its neighbors with a lower gradient to destination. Neighbor gathering via slow probing and gradient generation via fast probing allows a station to develop a number of choices of stations with lower cost to any destination that can send messages to such destinations. The neighbors are maintained all the time via slow probing and gradients are only developed on a needs basis when messages need to be sent to stations that are not neighbors.

The ODMA methodology, particularly with regard to the use of neighbor tables and gradient tables, is described in detail in International patent application no. PCT/IB2004/004111 entitled Probing Method for a Multi-Station Network, the contents of which are incorporated herein by reference.

### ODMA Over Ethernet

Probing is undertaken via Ethernet broadcast packets. Data transmission is effected via directed Ethernet packets. No RTS (request to send message) would be necessary, just a simple ACK (acknowledgement). There is only one channel in the medium, so the probing and data transmission would always use the single channel data transport protocol. Since slow probing is done relatively rarely, and neighbor costs are essentially all the same, the neighbor table could have a large number of neighbors relative to other media.

FIGS. 1(a) and 1(b) show one of the type B stations at the originating station region of the global network being connected to two Ethernets. This would occur, for example, in an office environment where a user station requires connectivity with the local area networks of different business units. In such circumstances, the type B stations would operate in a manner similar to the type A stations in the wireless medium. The type B station has effectively developed two sets of neighbors (each on the sections of the Ethernet joined by the ODMA unit). If one local area network is particularly busy and over utilized for either global or local traffic, the ODMA methodology is applied to the traffic in both neighborhoods. Each Ethernet group of stations cannot see the other group's stations as neighbors, but the type B station acts as an intermediary which matches stations in each group when appropriate thereby serving as a local area multi-hop relay and facilitating one or more hops over the neighborhoods in the Ethernet medium. It will be appreciated that more than one type B station could be joined to two (or more) local area networks of this nature.

More detail regarding the actual transport mechanism of ODMA packets through the Ethernet medium is provided below, in so far as it relates to the Internet medium.

### ODMA Over Internet

### Overview of the Global Network

The general ODMA environment envisages that every type A station (wireless client stations and seed stations) in the network repeatedly sends updated authentication messages on a periodic basis to the Authentication Servers. Gradients from each station in the network to any number of potential Authentication Servers are maintained at all times. These Authentication Servers interact with each other to maintain updated tables of information on every station comprising the ODMA network (in fact all ODMA stations of any type will authenticate themselves on an ongoing basis).

When a wireless type A station sends a packet to the Authentication Server (up a gradient to the Authentication Server), it includes the information for the predetermined number of best type C (Ethernet to Internet adapter) stations that it has determined provide the best potential connectivity in the area of the type A station. Each time an authentication packet is sent to the Authentication Server it will follow a gradient via a type C station and this information will also be added to the authentication packet. The Authentication Server will consequently always have a relatively current record of the type A stations that are in the area of certain type C stations. In addition, the type A stations will know how to send an authentication to the Authentication Server at all times.

When any type A station (the originating station) wishes to send information to another type A station (the destination station), it sends a packet to the Authentication Server (typically via the best-placed type C stations in its area, although the message could in theory be transmitted over the wireless medium if the Authentication Server has this functionality). Packets may be sent to both the Authentication Server and type C stations nearby to establish the best route available from the originating station to the destination station over the auxiliary network, as the destination station might already be known to a type C station. In the description that follows, the Internet serves as the example of the auxiliary network.

At the simplest level, stations acting as nodes on the Internet do not need to access an Authentication Station as such. When switched on, with access to the Internet (or other packet switched network), the station will automatically start probing for neighbors. There could be one or more initial addresses provided in the station's hardware to get the process going, and the addressee station(s) probed will provide information in respect of their own well connected neighbors and thereby advise of other stations that could be probed. All stations will ultimately locate each other in this manner as more addresses are made available to probe. As these neighbors are generally well connected, it is likely that they will have good connectivity with other well connected neighbors which ensure optimal transactions generally.

As each station maintains lists of wireless stations with which it is potentially in contact, a station on the Internet can locate wireless stations through this probing mechanism as well. The neighbor tables of the stations are updated on an ongoing basis, so any station should be able to keep track of well connected neighbors of its own and those of the destination station (whether on the auxiliary network or the wireless network). Once found, the key stations to probe as neighbors on demand can be updated continuously for as long as needed.

Assuming that the destination station is not immediately known to the type C stations or their immediate neighbors, the Authentication Server will then determine the last known location of the destination station and establish from its tables which type C stations appear best suited for connectivity between the originating and destination stations. The Authentication Server will tell the type C stations on the “originating side” of the Internet which other type C stations to probe via UDP on the “destination side.” The best type C stations (as may be determined on an ongoing basis thereafter) in the region of the originating and destination stations will then be probing each other as long as the stations on both sides of the Internet “hop” require a gradient between them.

### The Mechanism—Access to the Internet Medium

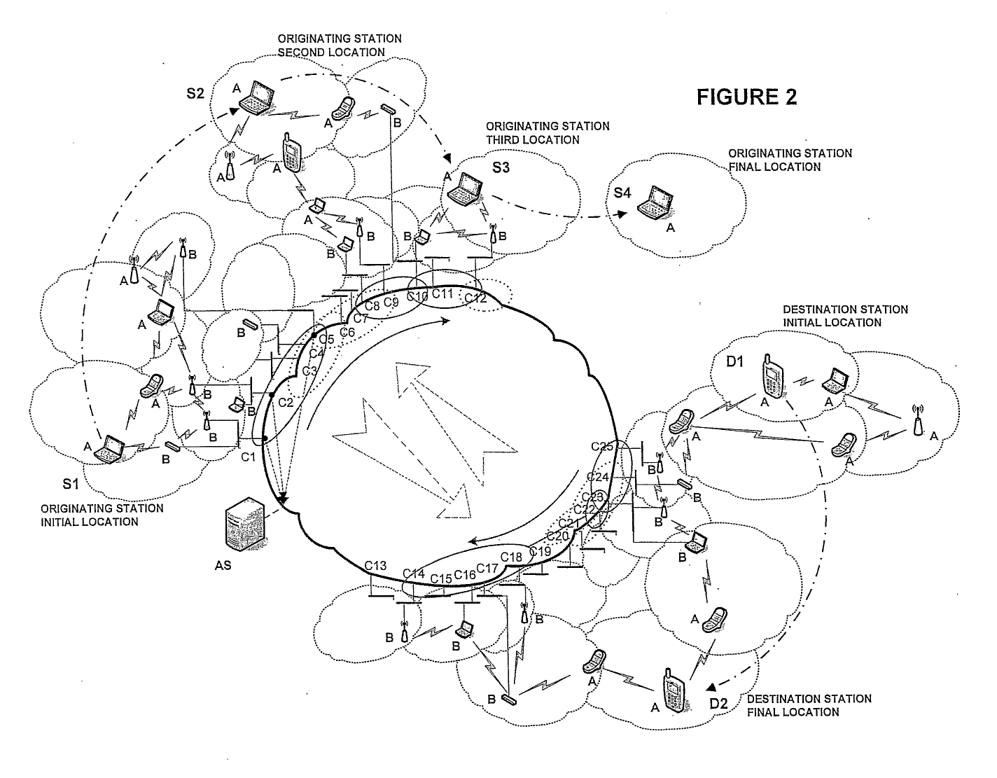

If the type A stations are mobile and move sufficiently far away from the initial set of type C Internet stations (that were originally determined as providing the best gradients) or if the quality of connectivity deteriorates for some other reason, the type A stations will stop using those initial C type stations (which are no longer suitable to maintain gradients) and instead will utilize other type C stations which are better suited to maintain gradients. This process is illustrated in FIG. 2.

The type A originating and destination stations, that are transmitting data between themselves, are able to keep informing each other regarding the identities of the best type C stations available in their own area. This means that the originating and destination stations can each then tell their respective type C stations on their own side which type C stations on the other end to probe via UDP. In FIG. 2, an originating type A station initially located at a position S1 wishes to send TCP/IP data to another type A destination station initially located at a position D1. The originating station has suitable connectivity through several type C stations C1, C2 and C5. It should be clear from the illustration that gradients to the type C stations can be established through numerous routes with multiple hops being possible through similar stations. For example, the path could be direct from A-B-C, or indirect through A-A-B-B-C, or even A-A-B-A-B-C etc.

The type C stations will maintain gradient information (number of hops and cost) between every type A station and themselves. The type C stations within a certain quality of connectivity will also inform other type C stations about their gradients to the type A stations and may possibly also inform the Authentication Server in certain circumstances. Type C stations obtain this gradient information by radiating gradients outwards through probes and each type A station (within a certain number of hops—say 10 hops) will keep track of these gradients (each of its neighbors will announce the cumulative costs to that point). The type A stations thereby maintain information regarding all the type C stations available to them and can choose the best ones from these stations (and will know if these should change). This information is relayed to the Authentication Server periodically.

Depending on the quality of the connectivity the message data will move from the originating type A station to the appropriate type C station via a type B station. The route is determined as a function of cost and need not necessarily be directed over the fewest number of hops. It should also be noticed in the illustration that certain type B stations are located at a great distance from the type C stations. Consequently, not only may the type A station be located geographically far away from the type B stations, possibly requiring several hops between type A stations, but the type B stations may also be far away from the type C stations. Moreover, as it is the capacity and quality of connectivity that is important the type B station utilized in the route may not be the station located closest to the type A station—otherwise the problem to be addressed would be trivial.

Similarly, on the destination side, the type A destination station initially has Internet access at C23 to C25 through numerous paths. The Authentication Server is then contacted (by the originating station acting through the type C station) for information on the location of the destination station. Stations C1, C2 and C5 start probing each other, as well as probing the type C stations on the destination side (this is described later in the document). The Authentication Server is not typically required thereafter. Once the gradients between the originating and destination stations have been established, data will be transported between the stations.

As the type A stations and their neighbors move relative to the type B stations (the originating station moves to location S2 and the destination station to location D2) the relevant type C stations on each side change. For the same originating station the best C stations gradually are replaced (as indicated in the drawing through encircled C stations) until the second location S2 is reached, where stations C8 to C10 are the best suited access points. As a new type C station is detected by the originating station this information is relayed to the other type C stations involved in both the source and destination groups. In this manner the clouds of potential connectivity on both sides are monitored in respect of the type C stations that are potentially required and those which are no longer relevant. This information is also sent at some point to the Authentication Server as an authentication, but if the connected type A stations are moving very rapidly (so that type C station neighbors are also changing rapidly) the algorithm could provide that the Authentication Server be notified immediately of any type C station changes to ensure that the type A station can be located. At a third location S3 of the originating station, stations C10 and C12 are relevant on the originating side, while at a final position S4 there is no longer any ODMA network connectivity available at all.

Stations C23, C14 and C16 to C18 are available on the destination side when the destination A station is located at its final location D2. The original type C stations that are no longer suitable (every initial station except C23) will be told to stop probing, or will time out after a certain delay. In other words, if the neighbors originally considered available are still relevant as connectivity options, but are not actually being used, they may be probed to keep them “alive” or available. Alternatively, these stations could continue probing until they no longer hear activity through probes or responses from their neighbors (within a certain number of hops). The drawing also illustrates that when the destination station is at the location D2 the most suitable type C station neighbors may not be the closest located stations.

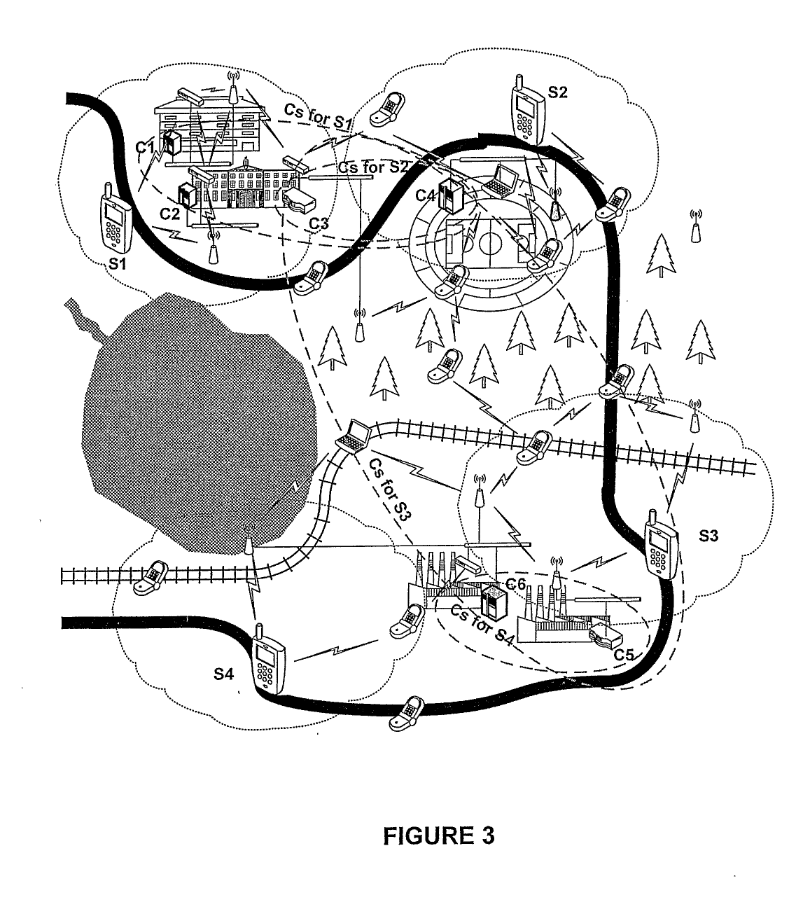

FIG. 3 illustrates the same concept as FIG. 2, but from the perspective of one A type station. In this example, the mobile type A station is a “smart phone” moving along a road from an initial position S1 to a final position S4. As the mobile station moves, the type C stations that serve as its access points to the Internet are gradually changing. At location S1 of the mobile station, in an urban area, the type C stations C1 to C4 are available for connection with the Internet medium. At position S2, in a suburban area, only type C stations C1 and C2 are available. As the type A station moves to location S3, in an industrial area, type C stations C3 to C6 are available, even though the mobile station is remote from both the urban and suburban areas, by virtue of other mobile station users located on the railway and in the forest. At a final location S4, in a more isolated area, there are fewer type A and type B stations and here only type C stations C5 and C6 are suitable.

The important feature that is reinforced in the illustration is that the type C stations generally remain relatively stable as the mobile station moves around, but there are usually choices available. Stations C3 and C4, for example, were available to the mobile type A station for most of the trip. The importance of this is that the number of hops between type A stations and between type A and B stations can be increased in getting to the type C stations. If there was only one available hop to a type C station then opportunities would be lost.

It can be noted that the Authentication Server is typically only used to start the communication process (as illustrated in FIG. 2). Once packets are flowing between originating and destination stations, the originating and destination stations will revise the list of type C stations that need to be probed on the other side, based on opportunities that are available at any given time. Each type A station continuously determines the best type C stations in its area and the data sent out will accordingly be routed optimally to these stations. In addition, from time to time the identities of the list of the best type C stations will be communicated as a part of the information included in the packets sent to the other side, being the best suited type C stations to probe in any reply.

Consequently, the source and destination stations are keeping each other informed regarding their connectivity information. This can be achieved in undertaken in any number of ways—for example, the source and destination stations can forward the information to all the type C stations to one or both groups, or the type C stations could update each other, etc. In any event, if connectivity with either the source or destination station is lost for some reason, the type C stations may still be instructed to maintain gradients for a while, as they would ordinarily time out after a predetermined delay period, in an attempt to locate the station from the most recent information available. Once the station is relocated, a more efficient route can then be established for ongoing communication. Obviously the stations can also request information from the Authentication Server if this is more up to date.

Based on the information received, data sent back to the first side in reply will be routed through the last known best type C stations identified. Once the originating and destination stations no longer require a connection between them and do not need the gradient information, they tell the type C stations to stop probing the other type C stations on the other side. This feature of utilizing only the most relevant type C stations (referred to as “neighbors on demand”—see further description below) is at the heart of the ODMA over “Wire” aspect of this invention and is the mechanism that enables the wide area global ODMA network to function efficiently.

### The Mechanism—Connectivity Through the Internet Medium

ODMA over Internet is a means of communicating between stations that are possibly significantly geographically remote relative to one another, using the Internet as the communications medium. Since broadcasting over the Internet is not possible (as messages are transmitted to addressed destinations) the set of neighbors is determined by gradient requirements. If information is required in respect of a gradient to a particular type A destination station, then an Authentication Server is accessed for information on the last known whereabouts (in respect of connectivity) of the destination station. The server should have such information available since each type A ODMA station is periodically required to authenticate itself and this information is recorded and retained at the Authentication Server. The Internet addresses of the most suitable known Ethernet to Internet adapters (type C stations) available to the destination station will then be returned to the type C stations available to the originating station and these can be used by the type A station as potential neighbors to probe.

Cost functions in this medium would depend on criteria such as Internet delays (which could be ascertained by “pinging” the required neighbors) and by determining transport time via a probing mechanism that is akin to the “slow probes” used over the wireless medium.

The ODMA over Internet methodology uses the User Data Protocol (UDP) to transport data between computers in the form of “datagrams.” UDP is a connectionless transport-layer protocol which has a packet structure into which data and headers can be provided, and all probing and data transport in ODMA over Internet is undertaken via UDP using standard protocols. The UDP headers include four fields that contain information on the originating and destination ports, the length of the data and a checksum (which provides an optional integrity check on the UDP header and data). More information on UDP is readily available on the Internet, but some detail can also be found at the following website: http://compnetworking.about.com/od/networkprotocols/l/aa071200a.htm.

The transmission process through the Internet medium utilizes UDP data packet protocols extensively—probes are sent using UDP, transport is achieved using UDP and acknowledge packets use UDP. All the contents of the ODMA packets (which also have their own headers that are available from source to destination) can be placed inside a UDP packet, with an ODMA header attached, and the UDP packets are then transported over the Internet. The ODMA contents of the UDP packet can first be encrypted for authentication and security. Typically, encryption will be undertaken at the source station for security all the way to the destination. Obviously if other suitable packet structures other than UDP, or equivalent tools, are developed these could be utilized as may be appropriate.

There are two key differences between conventional ODMA over Wireless and ODMA over Internet data transmission:
In ODMA over Wireless, the neighbors of any particular station are principally dictated by those with the lowest required power to reach them. In ODMA over Internet, the neighbors are those that are “needed” or demanded—based on the need for connectivity between any two areas in the global network. These “ODMA Internet neighbors” are only maintained through “ODMA Internet probing” for a particular time, as required for a specific connection, during which ODMA packets pass (encapsulated in UDP packets) from one ODMA Wireless region or area to another via the Internet. These “neighbors on demand” will typically be demanded by one or more ODMA type A stations that need the connectivity between the two regions. The type C stations then match up with other type C stations through probing based on the specific requirement. In certain circumstances, type C stations may also “demand” neighbors as described below.
Wireless is inherently a broadcast medium, so when slow probing is used to gather neighbors, for example, the power of the broadcasted slow probes is adapted in order to reach neighbors that are close in terms of propagation (lowest path loss). Gradients are then developed via these neighbors using the fast probing mechanism, which is also a broadcast mechanism. With ODMA stations connected to the Internet, the concept of probing neighbors is very different as there is no effective broadcast mechanism, nor is there a basis for power adaption on the Internet. For ODMA over Internet, each station addresses sequential “ODMA Internet probes” to its “neighbors on demand” that have been identified. These ODMA Internet probes are essentially UDP packets containing ODMA probe information. To send an ODMA Internet probe to any “neighbor on demand”, a station needs the Internet address of the ODMA station so that the UDP packet can be sent to that address. Each station gets this address information from either the Authentication Server, or from the stations requiring or demanding the connectivity and maintaining a table with this information.

By sending UDP packets addressed to different Internet addresses (the UDP packet also contains ODMA probe information) and receiving back responses from these stations, each station effectively “probes” its “neighbors on demand” on an ongoing basis. In so doing, each station gathers information about these stations (how busy they are and whether they have capacity available, etc.) and the connectivity to these stations. So a particular ODMA station that is connected to the Internet (and being used for the Internet portion of the transmission) will send sequential UDP packets on a regular basis (at probing intervals) addressed to other ODMA stations on the Internet that are its “neighbors on demand.” the probes also provide an indication of the throughput and loss, thereby providing a measure of the quality of the connection.

These UDP probe packets will be delayed by some time (for example, as they pass over the Internet) and the delays between the ODMA “neighbors on demand” can be used as a measure of link quality between the sending station and its neighbors, much like the popular “ping” delay tests that are used to evaluate performance of the Internet. This can be achieved by a first station sending a UDP packet (Internet probe) to a second station (one of its “neighbors on demand”). The first station's probe includes a local timer that is activated when sent and which is registered upon return of a UDP packet from the second station (containing the timer). This effectively allows the first station to calculate the delay of the probe from the first station to the second and back again. Any lack of synchronicity between the two stations' clocks will be overcome—as the first station times the entire process and the second provides details of how long the information was held prior to its response (while the UDP packet was opened and the station registered that there was an ODMA packet that may have required some further action; and that a probe response was required to be encapsulated in a UDP packet and sent back to the first station). As stations are sending Internet probes (sending UDP packets that include timers, etc. in the packet bundle) to all their neighbors on demand, each station can work out effective costs (in terms of network delay for example) to its various “neighbors on demand.” This probing is akin to the “slow probing” carried out over the wireless medium. Obviously, separate slow probes could be applied for quality information and fast probes for gradient information if this is appropriate.

The probes passing between the originating station and the various ODMA “neighbors on demand” provide information on the applicable cumulative costs in the Internet medium (akin to “fast probing” in the wireless medium). Cumulative cost information is also developed using the wireless fast probing mechanism in the wireless medium from the originating station to the destination station as well. In this way, the gradient of effective cumulative costs passes from the originating wireless ODMA stations over the Internet to the destination stations. In this sense, there is only one Internet probe mechanism in the Internet medium that achieves the functions of both the slow and fast probes in the wireless medium.

The Internet probe is used to develop information about the quality of links, capacity, etc. of “neighbors on demand” and, in addition, is used to move gradients from one region to another. Hence any gradient that starts at an originating station in a wireless medium may first point to other wireless stations, then via an ODMA Internet type C station to one or more other type C stations, followed by wireless stations to the destination station. This gradient will only last as long as the originating and destination stations require connectivity, and the ODMA “neighbors on demand” will only keep probing each other as long as a gradient through them is needed. In this way, the probing via the Internet is minimized and the probing will only last as long as demanded by one or more stations.

When data is actually transported across the Internet between ODMA type C stations, the data transport route is modified in that ODMA stations on the Internet will look at their own gradient tables for the costs of routing through their neighbors to the destination station, and then data packets (inside UDP packets) are addressed to the various neighbors and acknowledgements awaited. Since delays on the Internet may be relatively long, a number of ODMA data packets may be sent out in sequence to various stations before an acknowledgement is expected, and packets may be sent in bursts (groups of packets) or to a number of potential stations with anticipated lower costs. In addition, data from more than one type A station can be combined in packets for routing to mutually required nodes along the route. If packets are not acknowledged after a time-out period, a packet will be resent via another potential candidate neighbor. Each relay point along the route has error and cyclic redundancy code checking. Since ODMA data transport allows for end-to-end acknowledgement and end-to-end sequencing of data, the lost or out-of-sequence packets that could result from the data transport via the Internet will be sorted out and collated by the originating and destination stations.

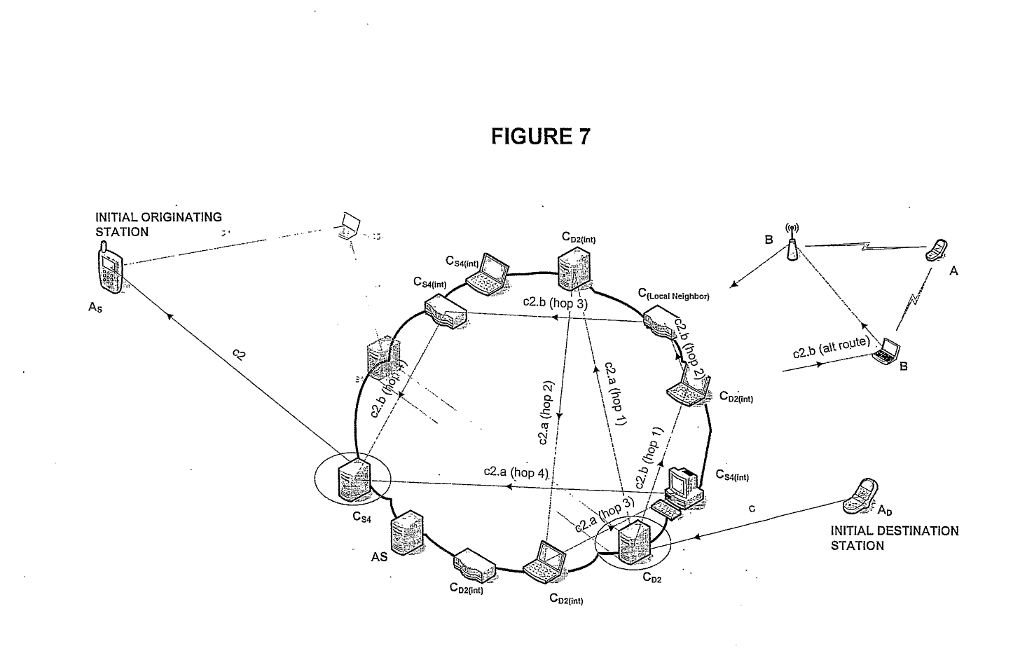

It should be appreciated that the actual routing between the C type stations on the originating and the destination sides of the Internet medium may require that the route passes through multiple intermediate ODMA Internet type C station hops, or even through wireless hops between these stations, prior to reaching the identified Internet type C station neighbor at the other end. The route adopted is opportunistic and based on the quality of connectivity available. In this respect, the operation of ODMA over Internet is much the same as ODMA over Wireless, where several hops may prove more efficient and desirable (with a lower cumulative cost) than a single hop, depending on how the Internet routers are set up at the addressed station. (This concept is illustrated in more detail in an example provided below with reference to FIG. 7).

The means of connectivity from one type A ODMA unit to another, where a hop through the Internet is required, will require a number of steps. The originating type A unit will convert the original message data into ODMA data packets. If the data is voice data, the signal is compressed, digitized and placed in the ODMA packets. If the data is TCP/IP format data, these packets are encapsulated in the ODMA packets and TCP/IP headers added. The ODMA packets may then be transported using ODMA over Wireless through other type A stations to the type B stations, where the ODMA packets are placed in directed Ethernet packets, ODMA headers are attached, and the Ethernet packets are transported to the type C stations. The ODMA packets are then taken out of the Ethernet packets and error checked, the ODMA headers are stripped out, and the ODMA packets are placed into UDP packets (where ODMA headers are added). These UDP packets are sent to type C stations on the destination side of the Internet where the ODMA packets are taken out of the UDP packets (ODMA headers stripped away) and placed into Ethernet packets (headers added) for transport to the type B stations. The ODMA packets are taken out of the Ethernet packets and sent by ODMA over Wireless to the type A stations where the data is extracted as compressed, digitized voice data and converted to analogue signals, or converted back to TCP/IP as the case may be.

It will be appreciated that any ODMA station in the multi-hop path will only recognize the ODMA packets being transported by it, without being able to determine what form of data is inside. Equally, the applications communicating with each other will communicate using their own protocols, negotiating with each other as if the ODMA network was not there, thereby serving as a “virtual” connection.

Any probing carried out by the type C stations will also be undertaken using UDP, but communication between the Authentication Server and type C stations could be via UDP or TCP/IP.

### EXAMPLES

The invention may be understood more comprehensively by way of practical examples.

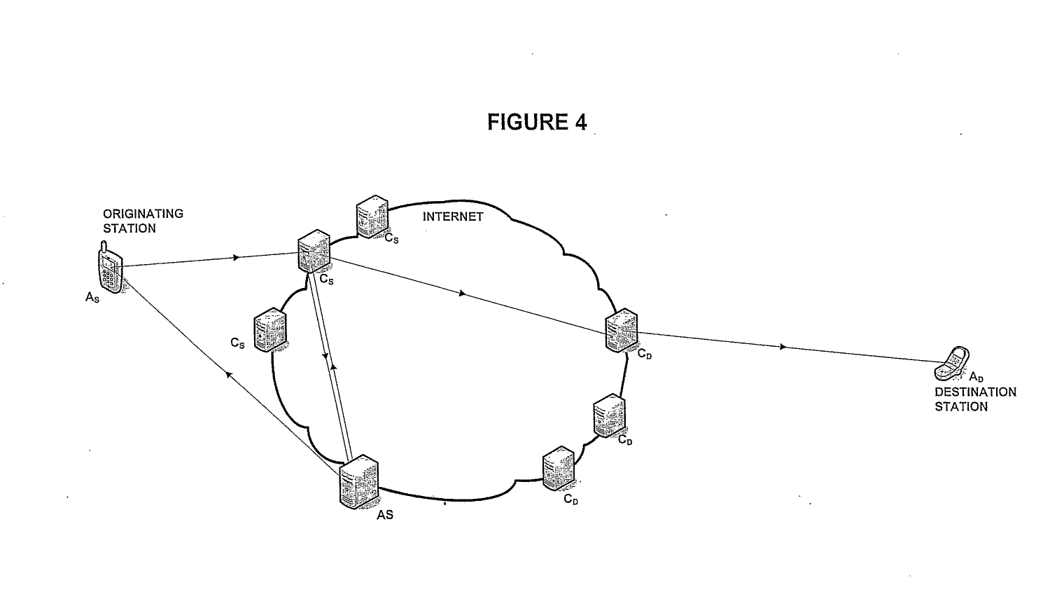

FIG. 4 shows a type A station (a mobile station having wireless connectivity) labeled station A_{S} that wishes to transmit data as an originating station to a destination station A_{D}. (Note that, for purposes of clarity, routing through the type B stations has been omitted in the illustration.) Both stations in the example are in wireless ODMA network environments. Initially the originating station A_{S} will attempt to locate the destination station A_{D} through fast probing techniques, broadcasting over the wireless medium in an attempt to create a gradient between them. If the destination station A_{D} cannot be located after a valid search (for example, the number of hops or the cumulative cost between the stations exceeds a predetermined maximum value), or if there is presently no connectivity in the wireless medium between them, other wired media, such as the Internet or another auxiliary network, can be utilized as one of the “hops”.

In generating its table of neighbors in its area of wireless connectivity, the station A_{S} will have established (according to standard ODMA protocols described in previous patent applications) that the station C_{S} is the most suitable ODMA Internet intermediate station available to it, and the data is consequently sent through the station C_{S} for onward transmission. However, as the ODMA Internet station C_{S} does not have any information regarding the whereabouts of the destination station A_{D} in its neighbor table, the station C_{S} accesses this information from the Authentication Server AS which has a specific, known Internet address. The Authentication Server could be decentralized and certain functions distributed to other stations (described below).

In the regular course of operation, all ODMA stations on the ODMA network are required periodically to report information regarding their connectivity to other stations and their connectivity whereabouts relative to the other stations to the Authentication Server. Based on its most recent authentication records received from the destination station A_{D}, the Authentication Server is in a position to suggest several ODMA Internet stations C_{D} which are available as potentially the best ODMA Internet intermediate stations with connectivity to the destination station A_{D}. This information (specific Internet addresses and last known gradient information) is communicated to the station C_{S} (and preferably also to the originating station A_{S}, as this information can be provided to new C_{S} stations near the station A_{S} in the event that better connectivity gradients become available between the station A_{S} and new C_{S} stations). The Internet station C_{S} then probes the C_{D} stations suggested by the Authentication Server and transmits the data to the station C_{D} that it determines has the best gradient (from C_{S} through to A_{D}). Upon receipt of the data packets at the station C_{D}, the best opportunity for onward transmission from C_{D} to A_{D} is determined by the station C_{D} and data is routed to the destination station A_{D} wirelessly using ODMA over wireless protocols.

By way of clarification, initially the potential gradients are propagated between the stations A_{S} and C_{S}. The station C_{S} in turn propagates gradients to the various C_{D} internet stations identified and multiple gradients are propagated thereafter to the destination station A_{D}. It must be appreciated that in the ordinary course, several C_{S} stations are initially “woken up” for possible use as a point of Internet access. These stations obtain the information regarding the destination station A_{D} from the Authentication Server (either independently of each other, or this information is communicated to them by another C_{S} station or by the originating station A_{S}). Prior to the C_{S} stations communicating with the C_{D} stations, only a certain limited number of C_{D} stations are “woken up” on the destination side as may be required.

The data transmitted by the station C_{S} includes connectivity information in the ODMA packets carried over the Internet by UDP packets, which is sent all the way to the destination station A_{D}. This connectivity information details the best gradients for connectivity between the wireless originating station A_{S} and the Internet station C_{S} that A_{S} selected at the time of sending the original data. The destination station A_{D} then may reply in a similar manner by providing data through to the best C_{D} station available to it at the moment it sends its own data transmission, informing the station C_{D} of the best known C_{S} options to probe (with Internet addresses and last known connectivity information back to the originating station as provided by the originating station) in order to establish the best routing back to the originating station A_{S}. In other words, the data sent from the destination station A_{D} to the originating station A_{S} will include details of the best C_{D} options that were available to the originating station A_{S} at the time of reply, as well as the best connectivity information provided when the originating data message was sent from A_{S}—and so the process is repeated between A_{S} and A_{D} until no more data is to be sent to either side. The type C Internet stations are then instructed to stop probing or will simply time out after a certain period of inactivity or if not instructed to continue.

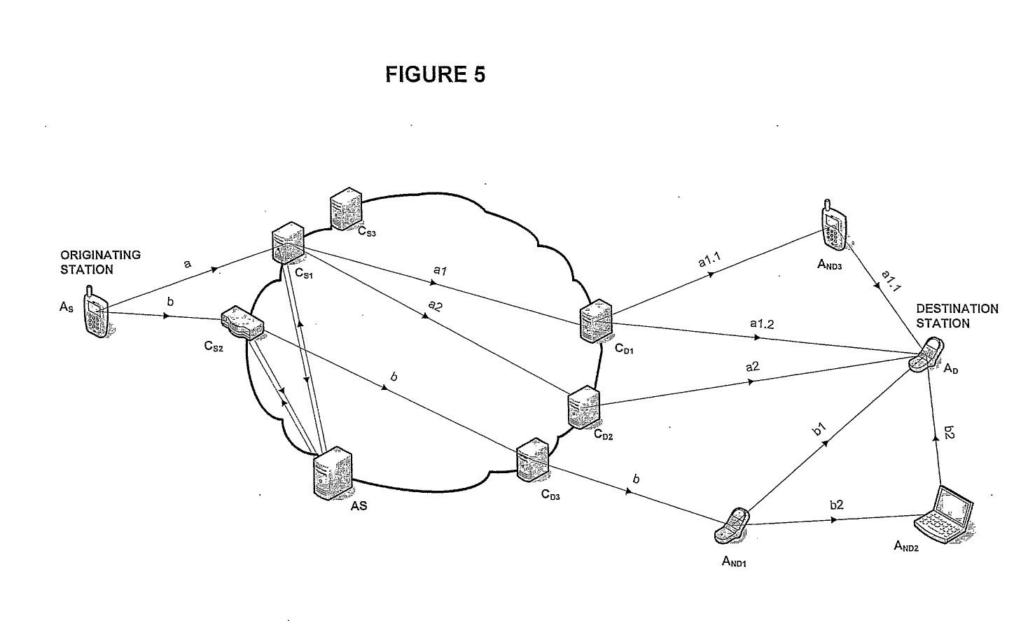

FIG. 5 shows a more complicated version of the process described in FIG. 4.

In this example, an originating station A_{S} has sent data opportunistically in two groups of packets (a) and (b) to Internet stations C_{S1} and C_{S2}. Prior to doing this, the station A_{S} had identified that Internet stations C_{S1-3} had the best available gradients through wireless to the Internet medium. The two Internet stations (C_{S1} and C_{S2}) then independently accessed the Authentication Server AS for information as to the latest known whereabouts of the destination station A_{D}. In the present example, the Authentication Server may have suggested the same C_{D} stations to C_{S1} and C_{S2} or it could have received newer authentication information from A_{D} prior to responding to one of them, say C_{S2}, and sent different station suggestions to probe on the destination side. In any event, C_{S2} probed the gradients available to the suggested C_{D} stations and thereafter routed the (b) data packets through C_{D3}. The (b) packets were then transmitted over an ODMA wireless network to an intermediate station A_{ND1} that established that it was a wireless neighbor of A_{D} and A_{ND2}, and opportunistically the (b) data packets were split up and routed in two sub-groups (b1) and (b2) to the destination station A_{D}, as illustrated.

In the meantime, the (a) grouping of data packets is opportunistically split up and transmitted in two sub-groups of packets (a1) and (a2), after probing by C_{S1} to C_{D1} and C_{D2}, respectively (and any other C_{D} stations that had been suggested by the Authentication Server). These sub-groups of packets were then sent to A_{D} by an opportunistic route using the standard ODMA wireless protocols.

As A_{D} has now acquired information on Internet station C_{S1-3}, in its reply to A_{S} it requests the best C_{D} Internet stations now available to it to probe these stations in order to determine the best potential connectivity with A_{S}. It will be appreciated that the Authentication Server should not be required or involved at all in the continuing communications between A_{S} and A_{D}, as the originating and destination stations each have information on each other's latest whereabouts.

Of course, in the event that the type C stations on the other side of the Internet return a message that the desired type A station cannot be located, the Authentication Server can again be accessed for suggestions to probe. It should also be appreciated that the station A_{D} is in no way committed to respond through the Internet medium and would be generating fast probes in the wireless medium to establish whether other gradients are available between A_{D} and A_{S} that have lower cumulative costs or hop counts through all the media available. The assessment of the ODMA environment is an ongoing process that is continually revised through probing to establish the best possible connectivity between stations that are possibly moving around relative to each other.

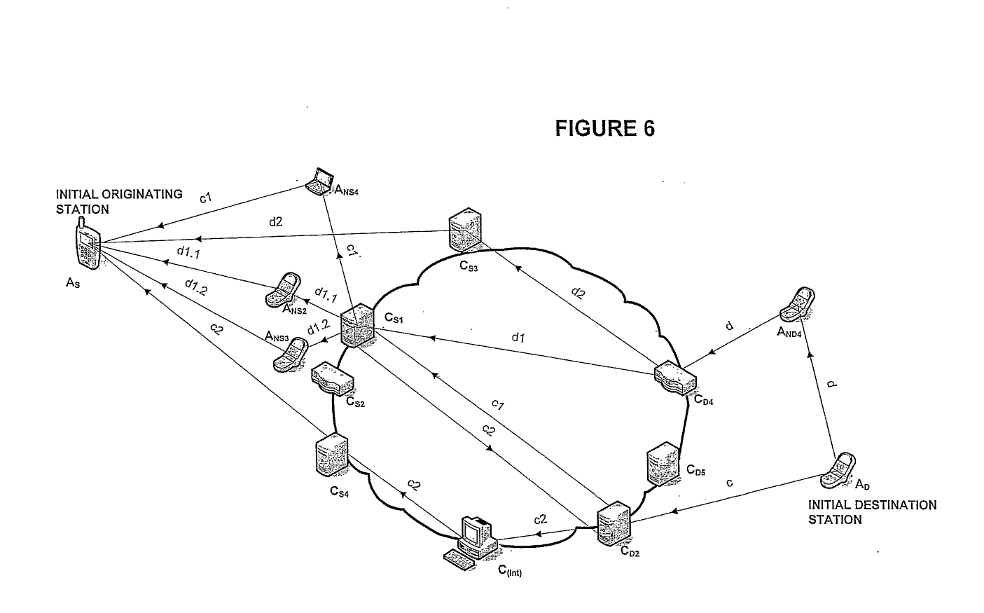

The example illustrated in FIG. 6 shows the response from station A_{D} following on from the above example. After probing by destination-side Internet stations C_{D}, it is determined that routing through C_{D2} to C_{S1} provides the best gradients for potential transmission from A_{D} to A_{S}.

However, while the data packets (c) are transmitted from A_{D} to C_{D2}, A_{D} establishes opportunistically that the Internet station C_{D4} now provides a more efficient route to the Internet medium, so a sub-group of data packets (d) is routed through this station. The Internet station C_{D4}, upon probing the source-side C_{S} stations, also establishes that, of the options originally suggested to it by A_{D}, station C_{S1} is still the best alternative. However, while transmitting the data problems are encountered and connectivity is either terminated or a more opportunistic path is recognized—so some information (d2) is instead routed through C_{S3}. The various sub-groups of packets are then reassembled at A_{S} after ODMA wireless routing between the C_{S} stations and the initial originating station A_{S}. This again demonstrates that the packets will be out of sequence and emphasizes the need for end-to-end flow control of sequencing, reordering of lost packets and reassembly in order to reconstruct the data from source to destination.

In the meantime, the link between C_{D2} and C_{S1} is interrupted for some reason, while (c) packets are being transmitted, and C_{S1} is no longer available. A message is returned to C_{D2} informing the station that packets are not being sent onward (or after a time-to-live period is exceeded) so (c2) packets are transmitted via an intermediate Internet station (C_{(int)—a known neighbor of C}_{D2}) to C_{S4}. The message is then sent in turn through the wireless medium to A_{S}. In response to the data received from A_{D}, station A_{S} would update its best Internet station connectivity information (which may or may not include stations C_{S1-4}).

FIG. 7 shows a more advanced version of the example described above in order to demonstrate that the Internet medium is a multi-hop ODMA opportunity in its own right. In this Figure, only the routing of the (c) packets has been represented for purposes of clarity. As before (shown in shadow format), the packets were originally directed to the C_{S1} station, with (c2) packets being returned to C_{D2} (although, as will become evident, the routing to C_{D2} need not have been direct as is illustrated).

The invention envisages that every type C station will maintain information regarding its neighbors having the best connectivity to it. These neighbors are not the “neighbors on demand” identified in respect of intended connectivity between type A stations. The type C stations probe for “well connected” neighbors as an ongoing background task. Establishing whether a neighbor is “well connected” for this purpose can be measured against a suitable set of criteria, such as the quality of connectivity to the type C station, or to the Internet itself. This information is maintained by the type C station. Stations with good connectivity will effectively advertise the fact, as they will be radiating gradients to stations around them and will be authenticating themselves to the Authentication Servers. Stations could also demonstrate capacity if they are idle. The Authentication Server could match up neighbors that have good connectivity and maintain this information or defer this role to another type C station to form a neighborhood of well connected stations.

When a type C station (such as C_{D2} in the example above) realizes that it has reduced connectivity it could probe progressively for other stations with good connectivity or request that the Authentication Server match it to stations with good connectivity that could serve as helpers. These helpers will not become overloaded as the number of neighbors available to the struggling station is limited. Well connected intermediate stations could assist with buffers or help with routing or gather information from the Authentication Server regarding how other stations can be assisted.

The assumption is that if the originating and destination type C stations each have good connectivity to another intermediate station on their own side that has good connectivity, then there must be good connectivity between the originating and destination stations. Therefore, there will typically be two intermediate stations through which packet routing is directed (in other words, three hops).

Returning to the illustration in FIG. 7, the (c2) packets are split up at the moment they are received and transported as (c2.a) and (c2.b) groups. C_{D2} and C_{S4} each have a number of well connected intermediate neighbor stations available (these could be anywhere in the world—the tests are the quality of connectivity and the capacity, not the physical location of the stations). The routing over four hops is illustrated. The (c2.b) group is first directed to one of the C_{D2} intermediate neighbors (C_{D2(int)}). However, at this point the connectivity to C_{S4}, or to any of its neighbors, is less desirable at the moment that the onward routing is about to occur. Routing is instead directed over a hop with a lower cost function to a C station known to the first C_{D2} intermediate station (C_{D2(int)}), and then onward to C_{S4} via a well connected neighbor of C_{S4}, namely C_{S4(int)}. It should be evident that the selection of opportunities available at the moment any routing takes place follows the general ODMA methodologies.

FIG. 7 additionally provides another example of alternative routing to the neighboring C station, through two type B stations (which may or may not be a part of the same Ethernet network) or between a type B station to a type A station over wire to another type B station. These routes could be followed if they proved to have a lower cumulative cost function than the direct connection between the type C stations, or if some of the load was being shed or spread to units with higher capacity.

The above examples serve to illustrate that the Internet may be understood in the ODMA context as an opportunity in its own right across the media available. Depending on factors such as the traffic loads and the strength of connectivity, routing will be adapted between an originating or source station A_{S} and a destination station A_{D} to find the most efficient path to the destination across the Internet, shedding and spreading packets as required, and awakening any Internet stations as is necessary with Internet connectivity on both sides. In this manner the load is continually spread when necessary and alternative options available are always being reassessed. In addition, routing over the Internet requires that the neighbors chosen in any specific connection exist as neighbors opportunistically as well, but only for so long as the demand for the ODMA over Internet connection exists.

This is a key innovation which enables units that are mobile to maintain a sufficient level of connectivity through a network with a wide area of coverage and multiple nodes, such as the Internet, but without overloading the network. This is achieved by updating the best connections available on a constant basis, limiting these updates to only the connections required, and then stopping the updates when the need for connectivity is terminated. This enables the transmission of data over the Internet in an ODMA network, while minimizing any unnecessary Internet activity and potential congestion.

Provided the ratio of stations with Internet connectivity to stations with wireless connectivity is maintained on a relatively stable basis (A and B stations to C stations), as the need arises (wireless and Internet stations lose coverage, data flow rates fluctuate, etc), a “cloud” of network coverage is dragged along with the communicating mobile stations at any given time. Both wireless and Internet stations may be activated and deactivated as necessary and constitute an adaptive pool of resources available to optimize the mobile station's connectivity. It will be appreciated that the ratio of type A stations to type B and C stations on the network will depend on the capacity and activity requirements of the type A stations.

If only a limited, predefined number of Internet stations provided access points, permitting transmission over the Internet medium, these stations would quickly become bottlenecks. However, in the ODMA over Internet process, Internet stations are woken up and discarded from the multitude of stations available as required. As each individual access point station available is not critical to connectivity, the stations may be of changeable and differing quality levels while still maintaining the quality of the network service to the mobile stations (possibly having poor power supply or undesirable geographic locations). The type C stations are not like typical base stations in other networks which are relied on completely. The ODMA network is resilient—with many choices of access points to the fixed network portion of the overall wide area (global) network being available.

It must also be appreciated that the global ODMA network does not necessarily require the use of the Internet medium as such. The problem being addressed is that despite the potentially limitless number of type A stations moving around relative to each other, some of these stations do not have any connectivity (or have poor connectivity) between them. The global ODMA network concept envisages a stable, packet switched auxiliary network between the wireless parts of the network.

The Internet is only one example of a packet switched network (running IP protocol over a variety of other network technologies). While the Internet presents one of the most useful options available, the present invention should not be understood as being limited to the use of this medium. The invention contemplates the use of any stable packet switched (“connectionless”) network where data is broken into smaller packets for transmission and switched to the destination (to “nodes” with known destination addresses) as an auxiliary network. The packets need not follow the same path or even a known path, instead they are dynamically routed and then reassembled in sequence at the destination.

As FIG. 1(b) illustrates, the packet switched auxiliary network medium may use other suitable networks, such as a network comprising satellites. In the Figure the type C station used on the originating station side has no Internet connectivity, but does fall within the “footprint” of a satellite. Consequently, the auxiliary network may comprise actual wired connections (like the Internet) and/or virtual “wired” connections available via satellite. The route actually adopted may include hops via both satellite and Internet stations depending on the opportunities available at the point of routing according to the gradient information developed at each station. Ethernet networks, X.25 and Frame Relay networks are other examples of packet switched networks.

The examples described above also illustrate that the cumulative cost assessment made by any given station is merely suggestive of the routing to be followed, but that this does not dictate the routing actually undertaken over the Internet. The route actually followed adapts with the changing environment that confronts the particular packets being transmitted at any point in the process as it moves down the gradient. This lack of commitment to a predetermined path means the packets of data do not get stuck, but can instead flow through any more appropriate alternative path that presents a better opportunity as required. The only criteria in determining the next opportunity is that the gradient always be improved, in other words the route must always go “down hill” to lower and lower cost points—but the decisions are made independently and opportunistically on a packet by packet basis. The essential feature is that choices are available at each hop. Provided a number of potential nodes are available at lower cost, even if some of these are relatively poor choices, the network will be stable and optimally efficient.

### Additional Roles of the Authentication Server

### Decentralization and Communication Hierarchy

In this document reference has been made to the roles of the Authentication Server. As stated above, there may be several Authentication Servers that have some means for sharing their information. On a true peer to peer network the stations (the type C stations) should be able to assist with routing, processing and high capacity tasks in order to decentralize the role of the Authentication Servers and reduce the load. For example, the Authentication Server could have a means of recognizing when a type C station has excess capacity and then stash information databases in such stations, or even allocate certain functions to these stations as helper stations. Other stations accessing the Authentication Servers for these functions could be referred to the helper station, or the helper station could be given a task to perform on behalf of the Authentication Server before reporting back to the Authentication Server or reporting directly to the station that had requested something from the server. In this way the Authentication Server maintains the communication hierarchy of the network, but minimizes the work that it itself must perform by utilizing and leveraging the resources of the type C stations. These spare resources will obviously grow as the network itself grows, so the solution is always scalable and the higher costs and resources associated with a centralized infrastructure are avoided. This also enables the Authentication Server to manage situations where regions are isolated to a greater or lesser extent from the global network, as well as in situations where there is uncharacteristically high demand for connectivity.

### Potential Barriers to Connectivity

The ODMA network assigns a fixed unique ODMA address to every unit on the network (these are 128-bit addresses so the number of potential units is virtually infinite). However, the Internet addresses are only 32-bit addresses (limiting the number of addresses available to just over 4 billion if address allocation were performed optimally, which is not the case) so many stations utilize a single public address through a process called Network Address Translation (NAT). In this system, the NATs rewrite network addresses and port numbers in IP protocol headers dynamically so the packets appear to be coming from and going to the public IP address of the NAT instead of the actual station.

The problem is that some protocols used by stations are not “NAT friendly,” in that some applications send IP addresses or port numbers hidden inside the data packets where NAT can not rewrite them. Consequently, these applications will not work if used on any station behind a NAT. ODMA communication is not affected by this as the ODMA packets are placed in UDP packets (with ODMA headers showing the unique ODMA address that will be recognized by the destination station). However, for security reasons, some NATs will only allow incoming traffic from an outside address if an outgoing packet has already been sent to that address. Consequently, if two C stations are behind NATs they may not be able to open up communications with each other.

This problem can be solved if a single UDP port in the UDP packet is utilized for certain ODMA connectivity data. At least one Authentication Server must have a public address (in other words not behind a NAT). Users connect to the Authentication Server and send the dynamic address of the intended destination, which the server matches to an ODMA address. The server then sends both stations a UDP packet with the address of the other ODMA units with ODMA information placed in the UDP port used. Both stations then send a packet to each other and a bidirectional hole will then be opened up by any NATs.

It will be appreciated that the Authentication Servers must maintain information about the various type C stations, which information includes whether the stations reside behind NATs, so the Authentication Servers can always get through NATs. Ideally, the type C station intermediary neighbor stations that are “well connected” (discussed above) will not reside behind NATs. However, as these groupings of well connected neighbors are identified, information permitting data to pass through NATs could be passed on to the other well connected stations in advance (and this information possibly maintained at one of the stations and be accessible to others to avoid the involvement of the Authentication Server each time data is to be sent).

### Security

Another area that potentially prevents connectivity between stations arises as a result of security features and firewalls. To prevent third party misuse of the ODMA stations (for example, mischievous overloading of the network by causing unnecessary probing, manipulating subscriber management and billing, accessing information in data or station databases, etc), every ODMA unit (including the Authentication Server) will require a smart card that is associated with a unique ODMA address. Any relaying station needs assurance that no information on the station will be accessed, and every sender of the data needs assurance that the data will not be accessed by the relaying stations. The Authentication Server will therefore provide reassurance to relaying stations through authentication of the source and destination stations, and provide reassurance to the end-users through encryption techniques. Both of these issues are achieved through the smart cards required at the stations.

### Gateways

The “wired” Internet medium also permits access to other services—such as to telephone networks through type E stations (Internet to PSTN adapters), and to real Internet access through type D stations (Internet to TCP/IP adapters). For a user of a mobile type A station to browse the Internet (for example using a laptop, a PDA or an Internet enabled cellular telephone) or to connect to a regular telephone network, the type A station must operate through the Authentication Server which matches the type A stations with the relevant gateways to the Internet.

### “Real” Internet Access

In order to browse the Internet, the Authentication Server will match the type A station with an appropriate type D gateway station, where conventional TCP/IP (or other similar protocols) and the ODMA protocol is translated/converted. In order for any station to access the Internet, that station requires identification as having a permanent or temporary Internet address.

ODMA identification addresses as such are not recognized by the Internet, so each ODMA unit accessing the Internet is allocated an Internet address which is stored at the type D gateway stations. As far as the Internet is concerned, the mobile type A station accessing the Internet is located at the type D station and appears as a fixed station with a fixed address. The permanent Internet addresses of ODMA enabled stations are stored along with corresponding ODMA addresses in a directory table (map). If an ODMA station has a permanent IP address then the directory map information can be provided to any ODMA station on the network requiring the information. If the ODMA station has a temporary address, then only the type D station needs to retain the information, and the type D station will allocate and map the temporary addresses to the ODMA user as needed to enable the connection. To the Internet, it appears that the type A stations are simply connected directly to the type D station at the permanent address of the type D station and appear to be fixed units. Obviously, when transmitting any data between the wireless (mobile) type A units and the type D gateways in the most opportunistic manner, any ODMA routing that actually takes place between the type A and D stations will be directed opportunistically by virtue of the gradients established, according to standard ODMA protocols.

If a type A station requires connectivity to the “real” Internet, the TCP/IP packets will be placed in the ODMA packets and sent as above to the type C stations. The type C stations will establish from the Authentication Server which type D station to use, and will send the ODMA packets in UDP packets to the D station. The type D station opens the ODMA packets in the UDP message and removes the TCP/IP data, which is then sent by conventional Internet routing to the desired Internet address. Data is then directed from the Internet to the type A station's permanent address at the type D station, where the TCP/IP data received is placed in ODMA packets and (after probing the type C station neighbors) is transported using UDP to the type C station having the most desirable gradient to the relevant type A station.

If an ordinary Internet user station (not using an ODMA enabled station) wishes to communicate with, and obtain data from, a destination station on the ODMA network through a permanent IP address, the data will have to be routed through a type D station where the ODMA and IP addresses will be matched together. All subsequent communication will then have to be routed via the type D station.

### Private ODMA Network Access

The Internet makes use of public addresses and private addresses. Without going into detail (information is readily available on the Internet), every station accessing the Internet requires a unique address. Often, however, for example in organizations, many of the users (who do not need direct Internet access as such or are part of a network or intranet) obtain Internet access through gateways such as proxy servers. The Internet addressing system consequently has a space reserved for only private address use. The addresses in the private space are not reachable on the Internet, but may only be accessed through gateways which have public addresses. Alternatively, private addresses are translated into valid public addresses by a network address translator (NAT) before being sent to the Internet. The above background is necessary to understand private ODMA network groups.

Certain ODMA users may form private ODMA groups or networks (where the users themselves may be physically located anywhere in the world), provided they have ODMA global network access. Each member of the group will maintain information mapping ODMA addresses with standard Internet private addresses of the group. If a group member wishes to access another computer in the group or access information from the network, the IP address will be mapped to the ODMA address and TCP/IP packets will be encapsulated in ODMA packets and sent directly from one ODMA station to another on the global network. This may be routed via the best type C station near the type A station user, through to the type D station. When the ODMA packet is taken from the UDP message, the type D station will recognize that the data is passing between members that are configured as part of the group or network. The ODMA data will then be placed in UDP packets and sent directly to the best type C destination station (accessing the Authentication Server for information on the location if necessary).

Management of the mapping of IP to ODMA addresses by the Authentication Server, or by the station allocated this function, is important—and legitimate up to date maps must be provided to all the group users regularly. In theory the Authentication Servers of different groups may share information in order to join groups, but this is not typical.

### Telephony Applications

A similar process to that described in relation to real Internet access above is undertaken in respect of the telephone connections made through type E stations. The Authentication Server will provide information on the best type E gateway that should be utilized in relation to any given type A station, and the Authentication Server will retain and provide access to directories (maps) of ODMA enabled equipment (e.g. ODMA addresses corresponding to “real” telephone numbers). However, in a telephone connection, the type E station chosen may be identified using additional criteria relevant to the call, such as the region of the destination station. This means that the most optimal connectivity in an ODMA sense may be compromised in favor of a type E station providing a lower financial cost for the call (to make the call a local call). In fact, with both the type D and E stations, there may be a large number of ODMA connections working through them at any given moment. It is consequently important that the load is monitored on an ongoing basis and the load spread out to other stations when necessary, even if this requires that the potentially best ODMA gradients are not utilized.

When connectivity is required between a type A station and “real” telephony applications, the type A station must be able to recognize the address required at the destination (the telephone number). The speech or other telephony signals (including video and data) are digitized and compressed, and these data packets are placed in ODMA packets together with the address information. Typically, standards such as H.323 are utilized for constructing the packets.

On an IP telephone, these signals would typically be encoded and placed in RTP packets (Real-Time Transport Protocol) and RTCP (Real-Time Transport Control Protocol) then transported over the Internet via UDP. If the destination is an IP telephone, the RTP packets generated using the H.323 standard can be encapsulated in ODMA packets and transported through to the type C stations. If the type C station recognizes that the packets are to be sent to an IP telephone, the ODMA packets can be sent by UDP to the appropriate type D station suggested by the Authentication Server, where the RTP and RTCP packets can be removed from the ODMA packets, placed in UDP packets and then sent to the IP telephone at its Internet address.

Any responses sent from the IP telephone back to the type A station will have an Internet address recognized by the type D station and the RTP packets will be extracted from the UDP packets, placed in ODMA packets and then into UDP. The UDP packets are then sent to the best type C station having connectivity with the original type A station, the ODMA data is removed from the UDP packets and sent all the way to the type A station where the RTP packets are removed. The H.323 is then taken out and the sound, video or other data signal is generated. It is implicit that H.323 functionality manages the telephony process, including the transport control, signaling and other telephony functionality required.

If the type C station had recognized that the destination was a PSTN unit, the packets would be placed in UDP packets and sent to the type E station suggested by the Authentication Server (located to provide the cheapest “real” connection with the destination). The type E station removes the ODMA packets, takes out the digitized data and communicates with the Public Switched Telephone Network. The PSTN will not recognize that the signal emanated from the ODMA network, the ODMA network providing a virtual connection between the real telephone and the telephone station at the ODMA unit. To the telephone connected indirectly to the type E station, the station will appear as simply another telephony application on the PSTN. Obviously the type E station will convert the voice data received into ODMA packets and send these back to the best type C stations having connectivity with the type A station.

In order to call an ODMA unit allocated a permanent PSTN telephone number, the call would be routed to a particular type E station and processed, mapping the number to the ODMA address. Where an ODMA station contacts another ODMA station using a regular telephone number, the type E station could possibly redirect the connection intelligently to the ODMA network

### Gateways and the Authentication Server

Gateways provide access to the Internet for the forms of service identified above, and many stations may operate through the gateways. The Authentication Server monitors the loads through the gateways and may refer wireless stations to other gateways having higher capacity or lower user loads if this is necessary. In general, only type C stations on the Internet recognize regular UDP transmissions transporting ODMA packets of data. Type D and E stations communicate with the real world applications using only TCP/IP and PSTN standardized protocols respectively (although obviously the type D and E stations transport ODMA to type C stations and the Authentication Servers using UDP packets). In order for these transmissions to be sent to and from type A stations, the TCP/IP and PSTN transmissions must be converted/translated into ODMA and vice versa at the type D and E stations.

It should be appreciated that the Authentication Server also tracks the billing associated with the connectivity to services such as Internet browsing and telephony, as well as any authentication necessary, providing the type D and E stations with the authorization to enable the connection. The type D and E stations may also be used to store records and/or gather summary information and send this back to the Authentication Server or another station. The manner in which the tracking and authentication takes place is described in more detail in International patent application no. WO 98/35474 entitled Secure Packet Radio Network, and may be achieved by tracking one or both ends of the connection, or by tracking the intermediate type D or type E station.

1. A method of operating a communication network, comprising a primary network and an auxiliary network, including a plurality of primary stations each able to transmit and receive data over the primary network, a plurality of bridge stations able to transmit and receive data both over the primary network and over the auxiliary network, and a plurality of auxiliary stations each able to transmit and receive data over the auxiliary network, the communication network being operable to transmit message data from an originating station to a destination station via at least one opportunistically selected intermediate station, the method including: monitoring, at each of a plurality of bridge stations, the activity of other stations on both the primary network and the auxiliary network to establish the availability of intermediate stations for onward transmission of message data from the originating station to the destination station; transmitting via the auxiliary network, from said at least one bridge station, probe signals to stations on the auxiliary network, the probe signals being addressed to at least one station on the auxiliary network; transmitting, from stations on the auxiliary network receiving probe signals from said at least one bridge station, response signals including connectivity data, thereby to identify at least one station on the auxiliary network available as an intermediate station for onward transmission of the message data to the destination station; and transmitting message data from the originating station to the destination station via at least one opportunistically selected intermediate station, including at least one bridge station.

2. A method according to claim 1 including transmitting via the primary network, from said at least one bridge station and from primary stations, probe signals to other primary stations, primary stations receiving the probe signals responding by transmitting connectivity data to indicate their availability as intermediate stations.

3. A method of operating a communication network comprising a primary network and an auxiliary network, including a plurality of primary stations each able to transmit and receive data over the primary network, a plurality of bridge stations able to transmit and receive data both over the primary network and over an auxiliary network, and a plurality of auxiliary stations each able to transmit and receive data over the auxiliary network, the communication network being operable to transmit message data from an originating station to a destination station via at least one opportunistically selected intermediate station, the method including: monitoring, at each of a plurality of primary stations and bridge stations, the activity of other stations on the primary network to establish the availability of intermediate stations for onward transmission of message data from the originating station to the destination station, the intermediate stations including bridge stations; transmitting via the primary network, from a station on the primary network with message data to transmit from the originating station to the destination station, probe signals to other stations on the primary network including at least one bridge station, thereby to identify at least one bridge station available as an intermediate station for onward transmission of the message data to the destination station; and transmitting message data opportunistically, from said station on the primary network with data to transmit and via said at least one bridge station, to the destination station.

4. A method according to claim 3 including transmitting via the auxiliary network, from said at least one bridge station, probe signals to stations on the auxiliary network via the auxiliary network, the probe signals being addressed to at least one station on the auxiliary network, thereby to identify at least one station on the auxiliary network available as an intermediate station for onward transmission of the message data to the destination station.

5. A method according to claim 2 or claim 4 including maintaining, at each bridge station, a neighbor table containing details of, and connectivity data relating to the availability of, primary stations and stations on the auxiliary network as destination or intermediate stations.

6. A method according to claim 5 including transmitting, from an auxiliary station with message data to transmit from the originating station to the destination station, probe signals to other stations on the auxiliary network, the probe signals being addressed to at least one station on the auxiliary network, thereby to identify at least one station on the auxiliary network available as an intermediate station for onward transmission of the message data to the destination station.

7. A method according to claim 6 including maintaining, at each auxiliary station, a neighbor table containing details of, and connectivity data relating to the availability of, auxiliary stations and bridge stations as destination or intermediate stations.

8. A method according to claim 5 wherein initial probe signals are addressed to one or more stations on the auxiliary network identified in data received from another station, or from an authentication station storing connectivity data relating to stations on the network, in order to identify one or more potential neighbor stations with good connectivity to the station transmitting the probe signals.

9. A method according to claim 8 wherein stations on the auxiliary network transmit probe signals to other stations on the auxiliary network from time to time in order to maintain a group of neighboring stations with good connectivity to such probing stations for potential future use as intermediate stations.

10. A method according to claim 5 wherein the primary network includes a wireless network and the primary stations include wireless stations.

11. A method according to claim 10 wherein the originating station is a wireless station and the destination station is an auxiliary station or bridge station on the auxiliary network.

12. A method according to claim 10 wherein both the originating station and the destination station are wireless stations, the method including transmitting probe signals via a station on the auxiliary network to at least one further bridge station and from said at least one further bridge station to at least one further wireless station, and transmitting message data opportunistically from said station on the auxiliary network and from said at least one further bridge station to the wireless destination station.

13. A method according to or claim 12 wherein the originating and destination stations maintain peer-to-peer connectivity via the auxiliary network.

14. A method according to claim 5 wherein the probe signals include neighbor gathering probe signals, stations receiving neighbour gathering probe signals from other stations responding by transmitting connectivity data to indicate their availability as intermediate stations.

15. A method according to claim 14 wherein the probe signals include gradient gathering probe signals, stations receiving gradient gathering probe signals from other stations responding by transmitting cost gradient data indicating the cumulative cost of communication between the stations.

16. A method according to claim 15 wherein the primary network and the auxiliary network utilize different transmission media, and wherein characteristics of the connectivity data and/or the cost gradient data are modified according to the characteristics of the primary network and the auxiliary network, depending on whether the station transmitting said data is a station on the primary network or the auxiliary network.

17. A method according to claim 15 wherein the cost gradient data is based on one or more cost functions determined from the time delay, data rate and packet loss experienced in message transmission between different stations and/or one or more cost functions determined from the relative load and resources available at each station.

18. A method according to claim 14 including transmitting, from each station, authentication messages to an authentication station, the authentication station operating to authenticate stations on the communication network from time to time and to store data relating to the connectivity of stations amongst themselves and with other intermediate stations including bridge stations, thereby enabling the neighbor gathering probe signals to be transmitted opportunistically between each station and selected bridge stations, or according to stored connectivity data provided by another station or by the authentication station.

19. A method according to claim 18 wherein the stations interact with said authentication station to maintain a record at the authentication station of bridge stations available to each station as intermediate stations from time to time.

20. A method according to claim 19 wherein some or all of the record maintenance is distributed by the authentication station through other stations in the communication network, effectively defining a distributed authentication station.

21. A method according to claim 18 wherein the stations are wireless stations that communicate with said authentication station and/or distributed authentication station via at least one bridge station.

22. A method according to claim 18 wherein the stations are wireless stations that transmit connectivity data relating to the availability to said wireless stations of bridge stations as intermediate stations when transmitting authentication data to said authentication station and/or distributed authentication station.

23. A method according to claim 18 wherein gradient gathering probe signals transmitted via said selected bridge stations to said at least one other bridge station are addressed to bridge stations identified by the authentication station and/or distributed authentication station as having connectivity to the destination station, directly or via one or more intermediate stations.

24. A method according to claim 18 wherein the gradient gathering probe signals transmitted via said selected bridge stations to said at least one other bridge station are addressed to bridge stations identified by other network stations as having connectivity to the destination station, directly or via one or more intermediate stations.

25. A method according to claim 23 wherein said selected bridge stations continue to address the gradient gathering probe signals to bridge stations previously identified by other stations as having had connectivity to the destination station, directly or via one or more intermediate stations, in order to maintain said previously identified bridge stations available as potential intermediate stations even when not required immediately as intermediate stations.

26. A method according to claim 25 wherein the gradient gathering probe signals are sent at predetermined probing intervals to said previously identified bridge stations until a connection is no longer required between the originating and destination stations.

27. A method according to claim 25 wherein the gradient gathering probe signals are sent as standard packet formats comprising ODMA data packets that define the probe signal characteristics.

28. A method according to claim 27 wherein the gradient gathering probe signals are sent as UDP datagram packets comprising ODMA data packets.

29. A method according to claim 27 wherein the gradient gathering probe signals contain cost function information on the cumulative cost of message transmission between stations having connectivity with one another, directly or via intermediate stations, for both primary stations and stations on the auxiliary network.

30. A method according to claim 29 wherein the primary network and the auxiliary network utilize different transmission media, the cost function information being calculated by appropriate weighting of the costs determined in the primary and auxiliary media, thereby ensuring that an optimal message transmission route is followed irrespective of the medium used to transmit the message data.

31. A method according to claim 5 wherein at least one gateway station on the auxiliary network has connectivity to an external network, said at least one gateway station having means for storing addresses of stations on the primary network and mapping them to addresses on the external network.

32. A communication network, comprising a primary network and an auxiliary network, for transmitting message data from an originating station to a destination station via at least one opportunistically selected intermediate station, the communication network including: a plurality of bridge stations, each bridge station being able to transmit and receive data both over the primary network and over the auxiliary network, and being operable to monitor the activity of other stations on the primary network and on the auxiliary network, to establish the availability of stations on the primary network or the auxiliary network as intermediate stations for onward transmission of message data from the originating station to the destination station; and a plurality of primary stations, each primary station being able to transmit and receive data over the primary network and being operable to monitor the activity of other stations on the primary network, to establish the availability of other primary stations or bridge stations as intermediate stations for onward transmission of message data from the originating station to the destination station, each primary station with message data to transmit from the originating station to the destination station being operable to transmit, via the primary network, probe signals to other stations on the primary network including at least one bridge station, in order to identify at least one bridge station available as an intermediate station for onward transmission of the message data to the destination station, thereby to transmit message data opportunistically, from said primary station with data to transmit and via said at least one bridge station, to the destination station.

33. A communication network according to claim 32 including a plurality of auxiliary stations each able to transmit and receive data over the auxiliary network, each bridge station being operable to transmit probe signals to stations on the auxiliary network, the probe signals being addressed to at least one station on the auxiliary network, thereby to identify at least one station on the auxiliary network available as an intermediate station for onward transmission of the message data to the destination station.

34. A communication network, comprising a primary network and an auxiliary network, for transmitting message data from an originating station to a destination station via at least one opportunistically selected intermediate station, the communication network including: a plurality of bridge stations, each bridge station being able to transmit and receive data both over the primary network and over the auxiliary network, and being operable to monitor the activity of other stations on the primary network and on the auxiliary network, to establish the availability of stations on the primary network or the auxiliary network as intermediate stations for onward transmission of message data from the originating station to the destination station; and a plurality of auxiliary stations, each auxiliary station being able to transmit and receive data over the auxiliary network and being operable to monitor the activity of other stations on the auxiliary network, to establish the availability of other auxiliary stations or bridge stations as intermediate stations for onward transmission of message data from the originating station to the destination station, each auxiliary station with message data to transmit from the originating station to the destination station being operable to transmit, via the auxiliary network, probe signals to other stations on the auxiliary network including at least one bridge station, in order to identify at least one bridge station available as an intermediate station for onward transmission of the message data to the destination station, thereby to transmit message data opportunistically, from said auxiliary station with data to transmit and via said at least one bridge station, to the destination station.

35. A communication network according to claim 34 including a plurality of primary stations each able to transmit and receive data over the primary network, each bridge station being operable to transmit probe signals to stations on the primary network, the probe signals being addressed to at least one station on the primary network, thereby to identify at least one station on the primary network available as an intermediate station for onward transmission of the message data to the destination station.

36. A communication network according to claim 33 or claim 35 including at least one authentication station arranged to authenticate stations on the communication network from time to time and to store data relating to the connectivity of stations amongst themselves and with intermediate stations including bridge stations, thereby enabling probe signals to be transmitted opportunistically between each station and selected bridge stations, or according to stored connectivity data provided by another station or by the authentication station.

37. A communication network according to claim 32 or claim 34 including at least one gateway station on the auxiliary network with connectivity to an external network, said at least one gateway station having means for storing addresses of stations on the primary network and mapping them to addresses on the external network.

38. A communication network according to claim 37 wherein the external network is the Internet and the gateway station stores a directory table in which addresses of stations on the primary network are mapped to Internet addresses.

39. A communication network according to claim 37 wherein the external network is a telephony network and the gateway station stores a directory table in which addresses of stations on the primary network are mapped to telephone numbers on the telephony network.
